(19) United States
(12) Patent Application Publication
(10) Pub. No.: US 2022/0197638 A1
(43) Pub. Date: Jun. 23, 2022

(54) GENERATING ENCRYPTED CAPABILITIES WITHIN BOUNDS

(71) Applicant: Intel Corporation, Santa Clara, CA (US)

(72) Inventor: Michael LeMay, Hillsboro, OR (US)

(73) Assignee: Intel Corporation, Santa Clara, CA (US)

(21) Appl. No.: 17/693,748

(22) Filed: Mar. 14, 2022

(51) Int. Cl. G06F 9/30

(52) U.S. Cl. CPC G06F 9/3016

(57) ABSTRACT

Techniques for generating an encrypted capability in computing hardware are described. The technology includes generating an encrypted capability with access only to specified bounds of a source capability when the specified bounds are within bounds of the source capability and generating an exception when the specified bounds are not within bounds of the source capability.

### BACKGROUND

Embodiments described herein generally relate to pointer generation in computing systems. In particular, embodiments described herein relate to cryptographic enforcement of access control to memory by encrypted capabilities in executing programs by computing hardware.

There is a tension between permitting a computer program to generate the pointers that the program legitimately requires for accessing memory belonging to the program versus generating pointers that the program can misuse to access memory for which the program does not have authorization. Capability machine architectures supporting Capability Hardware Enhanced Reduced Instruction Set Computing (RISC) Instructions (CHERI) limit generated capabilities to be based on prior valid capabilities such that generated capabilities do not exceed the bounds and permissions of the input capabilities. However, existing capability machines impose significant overheads (e.g., due to doubling of pointer sizes and requiring a tag bit for each word of memory).

### BRIEF DESCRIPTION OF DRAWINGS

Various examples in accordance with the present disclosure will be described with reference to the drawings.

FIG. 1 illustrates a block diagram of a hardware processor including a capability management circuit and coupled to a memory according to examples of the disclosure.

FIG. 2A illustrates an example format of a capability including a validity tag field, a bounds field, and an address field according to examples of the disclosure.

FIG. 2B illustrates an example format of a capability including a validity tag field, a permission field, an object type field, a bounds field, and an address field according to examples of the disclosure.

FIG. 3 illustrates a capability enhanced compiler according to one implementation.

FIG. 4 illustrates example computing hardware according to one implementation.

FIG. 5 illustrates assigning memory allocations to best-fitting, power-of-two aligned slots according to one implementation.

FIG. 6 illustrates an example of two compartments and access to an object by a pointer according to one implementation.

FIG. 7 illustrates an effect of executing an encrypt pointer within bounds instruction according to one implementation.

FIG. 8 is a flow diagram of encrypt pointer within bounds instruction processing according to one implementation.

FIG. 9 illustrates examples of computing hardware to process an instruction such as an encrypt pointer within bounds instruction.

FIG. 10 illustrates an example of method performed by a processor to process an encrypt pointer within bounds instruction.

FIG. 11 illustrates an example of method to process an encrypt pointer within bounds instruction using emulation or binary translation.

FIG. 12 illustrates an exemplary system.

FIG. 13 illustrates a block diagram of an example processor that may have more than one core and an integrated memory controller.

FIG. 14(A) is a block diagram illustrating both an exemplary in-order pipeline and an exemplary register renaming, out-of-order issue/execution pipeline according to examples.

FIG. 14(B) is a block diagram illustrating both an exemplary example of an in-order architecture core and an exemplary register renaming, out-of-order issue/execution architecture core to be included in a processor according to examples.

FIG. 15 illustrates examples of execution unit(s) circuitry, such as the execution unit(s) circuitry of FIG. 14(B).

FIG. 16 is a block diagram of a register architecture according to some examples.

FIG. 17 illustrates examples of an instruction format.

FIG. 18 illustrates examples of an addressing field.

FIG. 19 illustrates examples of a first prefix.

FIGS. 20(A)-(D) illustrate examples of how the R, X, and B fields of the first prefix are used.

FIGS. 21(A)-(B) illustrate examples of a second prefix.

FIG. 22 illustrates examples of a third prefix.

FIG. 23 illustrates a block diagram contrasting the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for an enhanced Cryptographic Computing (CC) instruction that generates encrypted pointers/capabilities such that they require an input capability to specify the bounds which the new capabilities must not exceed. Each compartment in a multi-tenant workload can start from a root capability covering the entire memory space for that compartment and subdivide authorized access into allocations by supplying the root capability to the enhanced capability generation instruction. For example, the input capabilities can be CHERI capabilities, cryptographic capabilities, or implicit compartment bounds from a current compartment descriptor.

The technology described herein introduces a new instruction in the instruction set architecture (ISA) of computing hardware for generating an encrypted capability within the bounds of an explicitly or implicitly supplied capability.

Cryptographic Computing (CC) (as described in “Cryptographic Computing Using Encrypted Base Addresses and Used in Multi-Tenant Environments”, United States Patent Publication Number US20200201789A1, published on Jun. 25, 2020, incorporated herein by reference) controls which allocations can be accessed by binding data encryption to encrypted pointers, with both the pointer and data encryption keys installed in processors such that they cannot be accessed by unprivileged software. Special instructions can be used to generate correctly encrypted pointers based on the current pointer encryption key. That is an adequate level of control for single-tenant software in which all the memory allocators (e.g., the loader, the heap allocator, and the implicit stack allocator injected by the compiler) all trust each other. However, it does not suffice for multi-tenant software containing mutually distrustful memory allocators. In that case, finer-grained controls are needed to restrict each allocator to just the region from which it is authorized to issue allocations. Such finer-grained controls are provided by implementations described herein.

Software compartmentalization involves the decomposition of software into isolated components (called compartments herein) to mitigate the effects of security vulnerabilities by applying sound principles of security, such as abstraction, encapsulation, type safety, and least privilege and the minimization of what must be trustworthy

In the following description, numerous specific details are set forth. However, embodiments may be practiced without these specific details. In other instances, well-known circuits, structures and techniques have not been shown in detail to avoid obscuring the understanding of the description.

A (e.g., hardware) processor (e.g., having one or more cores) may execute instructions (e.g., a thread of instructions) to operate on data, for example, to perform arithmetic, logic, or other functions. For example, software may request an operation and a hardware processor (e.g., a core or cores thereof) may perform the operation in response to the request. Certain operations include accessing one or more memory locations, e.g., to store and/or read (e.g., load) data. In certain examples, a computing system includes a hardware processor requesting access to (e.g., load or store) data and the memory is local (or remote) to the computing system. A processor of a computing system may include a plurality of cores, for example, with a proper subset of cores in each socket of a plurality of sockets, e.g., of a system-on-a-chip (SoC). Each core (e.g., each processor or each socket) may access data storage (e.g., a memory). Memory may include volatile memory (e.g., dynamic random-access memory (DRAM)) or (e.g., byte-addressable) persistent (e.g., non-volatile) memory (e.g., non-volatile RAM) (e.g., separate from any system storage, such as, but not limited, separate from a hard disk drive). One example of persistent memory is a dual in-line memory module (DIMM) (e.g., a non-volatile DIMM) (e.g., an Intel® Optane™ memory), for example, accessible according to a Peripheral Component Interconnect Express (PCIe) standard.

Memory may be divided into separate blocks (e.g., one or more cache lines), for example, with each block managed as a unit for coherence purposes. In certain examples, a (e.g., data) pointer (e.g., an address) is a value that refers to (e.g., points to) the location of data, for example, a pointer may be an (e.g., virtual) address and that data is (or is to be) stored at that address (e.g., at the corresponding physical address). In certain examples, memory is divided into multiple lines, e.g., and each line has its own (e.g., unique) address. For example, a line of memory may include storage for 512 bits, 256 bits, 128 bits, 64 bits, 32 bits, 16 bits, or 8 bits of data, or any other number of bits.

In certain examples, memory corruption (e.g., by an attacker) is caused by an out-of-bound access (e.g., memory access using the base address of a block of memory and an offset that exceeds the allocated size of the block) or by a dangling pointer (e.g., a pointer which referenced a block of memory (e.g., buffer) that has been de-allocated).

Certain examples herein utilize memory corruption detection (MCD) hardware and/or methods, for example, to prevent an out-of-bound access or an access with a dangling pointer. In certain examples, memory accesses are via a capability, e.g., instead of a pointer. In certain examples, the capability is a communicable (e.g., unforgeable) token of authority, e.g., through which programs access all memory and services within an address space. In certain examples, capabilities are a fundamental hardware type that are held in registers (e.g., where they can be inspected, manipulated, and dereferenced using capability instructions) or in memory (e.g., where their integrity is protected). In certain examples, the capability is a value that references an object along with an associated set of one or more access rights. In certain examples, a (e.g., user level) program on a capability-based operating system (OS) is to use a capability (e.g., provided to the program by the OS) to access a capability protected object.

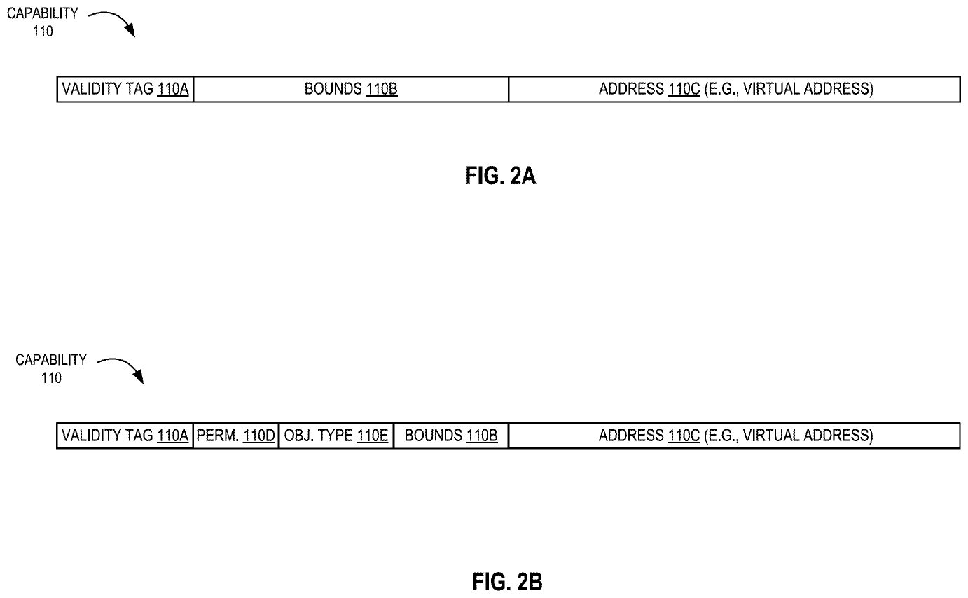

In certain examples of a capability-based addressing scheme, (e.g., code and/or data) pointers are replaced by protected objects (e.g., “capabilities”) that are created only through the use of privileged instructions, for example, which are executed only by either the kernel of the OS or some other privileged process authorized to do so, e.g., effectively allowing the kernel (e.g., supervisor level) to control which processes may access which objects in memory (e.g., without the need to use separate address spaces and therefore requiring a context switch for an access). Certain examples implement a capability-based addressing scheme by extending the data storage (for example, extending memory (e.g., and register) addressing) with an additional bit (e.g., writable only if permitted by the capability management circuit) that indicates that a particular location is a capability, for example, such that all memory accesses (e.g., loads, stores, and/or instruction fetches) must be authorized by a respective capability or be denied. Example formats of capabilities are discussed below in reference to FIGS. 2A and 2B.

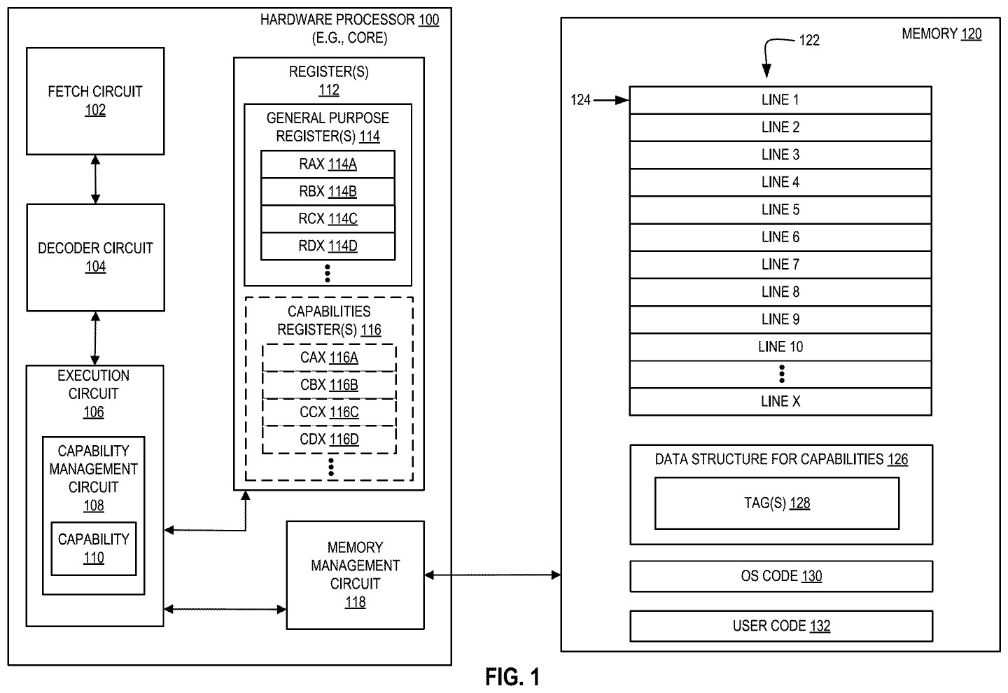

Turning now to the Figures, FIG. 1 illustrates a block diagram of a hardware processor 100 (e.g., core) including a capability management circuit 108 and coupled to a memory 120 according to examples of the disclosure. Although the capability management circuit 108 is depicted within the execution circuit 106, it should be understood that the capability management circuit can be located elsewhere, for example, in another component of hardware processor 100 (e.g., within fetch circuit 102) or separate from the depicted components of hardware processor 100.

Depicted hardware processor 100 includes a hardware fetch circuit 102 to fetch an instruction (e.g., from memory 120), e.g., an instruction that is to request access to a block (or blocks) of memory storing a capability (e.g., or a pointer) and/or an instruction that is to request access to a block (or blocks) of memory 120 through a capability 110 (e.g., or a pointer) to the block (or blocks) of the memory 120. Depicted hardware processor 100 includes a hardware decoder circuit 104 to decode an instruction, e.g., an instruction that is to request access to a block (or blocks) of memory storing a capability (e.g., or a pointer) and/or an instruction that is to request access to a block (or blocks) of memory 120 through a capability 110 (e.g., or a pointer) to the block (or blocks) of the memory 120. Depicted hardware execution circuit 106 is to execute the decoded instruction, e.g., an instruction that is to request access to a block (or blocks) of memory storing a capability (e.g., or a pointer) and/or an instruction that is to request access to a block (or blocks) of memory 120 through a capability 110 (e.g., or a pointer) to the block (or blocks) of the memory 120.

In certain examples, capability management circuit 108 is to, in response to receiving an instruction that is requested for fetch, decode, and/or execution, check if the instruction is a capability instruction or a non-capability instruction (e.g., a capability-unaware instruction), for example, and (i) if a capability instruction, is to allow access to memory 120 storing (1) a capability and/or (2) data and/or instructions (e.g., an object) protected by a capability, and/or (ii) if a non-capability instruction, is not to allow access to memory 120 storing (1) a capability and/or (2) data and/or instructions (e.g., an object) protected by a capability. In certain examples, capability management circuit 108 is to check if an instruction is a capability instruction or a non-capability instruction by checking (i) a field (e.g., opcode) of the instruction (e.g., checking a corresponding bit or bits of the field that indicate if that instruction is a capability instruction or a non-capability instruction) and/or (ii) if a particular register is a “capability” type of register (e.g., instead of a general-purpose data register) (e.g., implying that certain register(s) are not to be used to store a capability or capabilities). In certain examples, capability management circuit 108 is to manage the capabilities, e.g., only the capability management circuit is to set and/or clear validity tags. In certain examples, capability management circuit 108 is to clear the validity tag of a capability in a register in response to that register being written to by a non-capability instruction.

In certain examples, the source storage location (e.g., virtual address) for a capability 110 in memory 120 is an operand of an (e.g., supervisor level or user level) instruction (e.g., having a mnemonic of LoadCap) that is to load the capability from the memory 120 into register(s) 112. In certain examples, the destination storage location (e.g., virtual address) for capability 110 in memory 120 is an operand of an (e.g., supervisor level) instruction (e.g., having a mnemonic of StoreCap) that is to store the capability from the register(s) 112 into memory 120. In certain examples, the instruction is requested for execution by executing OS code 130 (e.g., or some other privileged process authorized to do so) and/or by executing user code 132.

In certain examples, capability management circuit 108 is to enforce security properties on changes to capability data (e.g., metadata), for example, for the execution of a single instruction, by enforcing: (i) provenance validity that ensures that valid capabilities can only be constructed by instructions that do so explicitly (e.g., not by byte manipulation) from other valid capabilities (e.g., with this property applying to capabilities in registers and in memory), (ii) capability monotonicity that ensures, when any instruction constructs a new capability (e.g., except in sealed capability manipulation and exception raising), it cannot exceed the permissions and bounds of the capability from which it was derived, and/or (iii) reachable capability monotonicity that ensures, in any execution of arbitrary code, until execution is yielded to another domain, the set of reachable capabilities (e.g., those accessible to the current program state via registers, memory, sealing, unsealing, and/or constructing sub-capabilities) cannot increase.

In certain examples, capability management circuit 108 (e.g., at boot time) provides initial capabilities to the firmware, allowing data access and instruction fetch across the full address space. Additionally, all tags are cleared in memory in certain examples. Further capabilities can then be derived (e.g., in accordance with the monotonicity property) as they are passed from firmware to boot loader, from boot loader to hypervisor, from hypervisor to the OS, and from the OS to the application. At each stage in the derivation chain, bounds and permissions may be restricted to further limit access. For example, the OS may assign capabilities for only a limited portion of the address space to the user software, preventing use of other portions of the address space. In certain examples, capabilities carry with them intentionality, e.g., when a process passes a capability as an argument to a system call, the OS kernel can use only that capability to ensure that it does not access other process memory that was not intended by the user process (e.g., even though the kernel may in fact have permission to access the entire address space through other capabilities it holds). In certain examples, this prevents “confused deputy” problems, e.g., in which a more privileged party uses an excess of privilege when acting on behalf of a less privileged party, performing operations that were not intended to be authorized. In certain examples, this prevents the kernel from overflowing the bounds on a user space buffer when a pointer to the buffer is passed as a system-call argument. In certain examples, these architectural properties of a capability management circuit 108 provide the foundation on which a capability-based OS, compiler, and runtime can implement a certain programming language (e.g., C and/or C++) with memory safety and compartmentalization.

In certain examples, the capability is stored in a single line of data. In certain examples, the capability is stored in multiple lines of data. For example, a block of memory may be lines 1 and 2 of data of the (e.g., physical) addressable memory 122 of memory 120 having an address 124 to one (e.g., the first) line (e.g., line 1). Certain examples have a memory of a total size X, where X is any positive integer.

In certain examples, capabilities (e.g., one or more fields thereof) themselves are also stored in memory 120, for example, in data structure 126 (e.g., table) for capabilities. In certain examples, a (e.g., validity) tag 128 is stored in data structure 126 for a capability stored in memory. In certain examples, tags 128 (e.g., in data structure 126) are not accessible by non-capability (e.g., load and/or store) instructions. In certain examples, a (e.g., validity) tag is stored along with the capability stored in memory (e.g., in one contiguous block).

Depicted hardware processor 100 includes one or more registers 112, for example, general purpose (e.g., data) register(s) 114 (e.g., registers RAX 114A, RBX 114B, RCX 114C, RDX 114D, etc.) and/or (optional) (e.g., dedicated only for capabilities) capabilities register(s) 116 (e.g., registers CAX 116A, CBX 116B, CCX 116C, CDX 116D, etc.).

Hardware processor 100 includes a coupling (e.g., connection) to memory 120. In certain examples, memory 120 is a memory local to the hardware processor (e.g., system memory). In certain examples, memory 120 is a memory separate from the hardware processor, for example, memory of a server. Note that the figures herein may not depict all data communication connections. One of ordinary skill in the art will appreciate that this is to not obscure certain details in the figures. Note that a double headed arrow in the figures may not require two-way communication, for example, it may indicate one-way communication (e.g., to or from that component or device). Any or all combinations of communications paths may be utilized in certain examples herein.

Hardware processor 100 includes a memory management circuit 118, for example, to control access (e.g., by the execution unit 106) to the (e.g., addressable memory 122 of) memory 120.

In certain examples, an indication (e.g., name) of the destination register for capability 110 in register(s) 112 is an operand of an (e.g., supervisor level) instruction (e.g., having a mnemonic of LoadCap) that is to load the capability from the memory 120 into register(s) 112. In certain examples, an indication (e.g., name) of the source register for capability 110 in register(s) 112 is an operand of an (e.g., supervisor level) instruction (e.g., having a mnemonic of StoreCap) that is to store the capability from the register(s) 112 into memory 120.

In certain examples, capability management circuit 108 uses capability-based access control for enforcing memory safety, e.g., and low-overhead compartmentalization. However, in certain examples, capabilities require a larger data width than a pointer, for example, using (e.g., at least 128-bit or at least 129-bit) registers that are wider than (e.g., 64-bit) the registers used to store pointers to allow for storage of a capability (e.g., a pointer along with its bounds, permissions, and/or other metadata). This introduces significant overhead within the design for expanded register files. Examples herein allow for (e.g., 128-bit or 129-bit) capabilities to span a plurality of (e.g., 64-bit) registers without expanding the register file, for example, without expanding the (e.g., logical) width of general-purpose registers to the capability width (e.g., 128-bits or 129-bits) and/or without defining an additional, separate register file to hold the width of the capability (e.g., 128-bit or 129-bit), e.g., because expanding registers and/or introducing new registers increases processor (e.g., silicon) area overhead and timing latency.

A capability may have different formats and/or fields. In certain examples, a capability is more than twice the width of a native (e.g., integer) pointer type of the baseline architecture, for example, 129-bit capabilities on 64-bit platforms, and 65-bit capabilities on 32-bit platforms. In certain examples, each capability includes an (e.g., integer) address of the natural size for the architecture (e.g., 32 or 64 bit) and additional metadata (e.g., that is compressed in order to fit) in the remaining (e.g., 32 or 64) bits of the capability. In certain examples, each capability includes (or is associated with) a (e.g., 1-bit) validity “tag” whose value is maintained in registers and memory by the architecture (e.g., by capability management circuit 108). In certain examples, each element of the capability contributes to the protection model and is enforced by hardware (e.g., capability management circuit 108).

In certain examples, when stored in memory, valid capabilities are to be naturally aligned (e.g., at 64-bit or 128-bit boundaries) depending on capability size where that is the granularity at which in-memory tags are maintained. In certain examples, partial or complete overwrites with data, rather than a complete overwrite with a valid capability, lead to the in-memory tag being cleared, preventing corrupted capabilities from later being dereferenced. In certain examples, capability compression reduces the memory footprint of capabilities, e.g., such that the full capability, including address, permissions, and bounds fits within a certain width (e.g., 128 bits plus a 1-bit out-of-band tag). In certain examples, capability compression takes advantage of redundancy between the address and the bounds, which occurs where a pointer typically falls within (or close to) its associated allocation. In certain examples, the compression scheme uses a floating-point representation, allowing high-precision bounds for small objects, but uses stronger alignment and padding for larger allocations.

FIG. 2A illustrates an example format of a capability 110 including a validity tag 110A field, a bounds 110B field, and an address 110C (e.g., virtual address) field according to examples of the disclosure.

In certain examples, the format of a capability 110 includes one or any combination of the following. A validity tag 110A where the tag tracks the validity of a capability, e.g., if invalid, the capability cannot be used for load, store, instruction fetch, or other operations. In certain examples, it is still possible to extract fields from an invalid capability, including its address. In certain examples, capability-aware instructions maintain the tag (e.g., if desired) as capabilities are loaded and stored, and as capability fields are accessed, manipulated, and used. A bounds 110B that identifies the lower bound and/or upper bound of the portion of the address space to which the capability authorizes access (e.g., loads, stores, instruction fetches, or other operations). An address 110C (e.g., virtual address) for the address of the capability protected data (e.g., object).

In certain examples, the validity tag 110A provides integrity protection, the bounds 110B limits how the value can be used (e.g., for memory access), and/or the address 110C is the memory address storing the corresponding data (or instructions) protected by the capability.

FIG. 2B illustrates an example format of a capability 110 including a validity tag 110A field, a permission(s) 110D field, an object type 110E field, a bounds 110B field, and an address 110C field according to examples of the disclosure.

In certain examples, the format of a capability 110 includes one or any combination of the following. A validity tag 110A where the tag tracks the validity of a capability, e.g., if invalid, the capability cannot be used for load, store, instruction fetch, or other operations. In certain examples, it is still possible to extract fields from an invalid capability, including its address. In certain examples, capability-aware instructions maintain the tag (e.g., if desired) as capabilities are loaded and stored, and as capability fields are accessed, manipulated, and used. A bounds 110B that identifies the lower bound and/or upper bound of the portion of the address space to which the capability authorizes access (e.g., loads, stores, instruction fetches, or other operations). An address 110C (e.g., virtual address) for the address of the capability protected data (e.g., object). Permissions 110D include a value (e.g., mask) that controls how the capability can be used, e.g., by restricting loading and storing of data and/or capabilities or by prohibiting instruction fetch. An object type 110E that identifies the object, for example (e.g., in a (e.g., C++) programming language that supports a “struct” as a composite data type (or record) declaration that defines a physically grouped list of variables under one name in a block of memory, allowing the different variables to be accessed via a single pointer or by the struct declared name which returns the same address), a first object type may be used for a struct of people's names and a second object type may be used for a struct of their physical mailing addresses (e.g., as used in an employee directory). In certain examples, if the object type 110E is not equal to a certain value (e.g., −1), the capability is “sealed” (with this object type) and cannot be modified or dereferenced. Sealed capabilities can be used to implement opaque pointer types, e.g., such that controlled non-monotonicity can be used to support fine-grained, in-address-space compartmentalization.

In certain examples, permissions 110D include one or more of the following: “Load” to allow a load from memory protected by the capability, “Store” to allow a store to memory protected by the capability, “Execute” to allow execution of instructions protected by the capability, “LoadCap” to load a valid capability from memory into a register, “StoreCap” to store a valid capability from a register into memory, “Seal” to seal an unsealed capability, “Unseal” to unseal a sealed capability, “System” to access system registers and instructions, “BranchSealedPair” to use in an unsealing branch, “CompartmentID” to use as a compartment ID, “MutableLoad” to load a (e.g., capability) register with mutable permissions, and/or “User[N]” for software defined permissions (where N is any positive integer greater than zero).

In certain examples, the validity tag 110A provides integrity protection, the permission(s) 110D limits the operations that can be performed on the corresponding data (or instructions) protected by the capability, the bounds 110B limits how the value can be used (e.g., for example, for memory access), the object type 110E supports higher-level software encapsulation, and/or the address 110C is the memory address storing the corresponding data (or instructions) protected by the capability.

In certain examples, a capability (e.g., value) includes one or any combination of the following fields: address value (e.g., 64 bits), bounds (e.g., 87 bits), flags (e.g., 8 bits), object type (e.g., 15 bits), permissions (e.g., 16 bits), tag (e.g., 1 bit), global (e.g., 1 bit), and/or executive (e.g., 1 bit). In certain examples, the flags and the lower 56 bits of the “capability bounds” share encoding with the “capability value”.

In certain examples, the format of a capability (for example, as a pointer that has been extended with security metadata, e.g., bounds, permissions, and/or type information) overflows the available bits in a pointer (e.g., 64-bit) format. In certain examples, to support storing capabilities in a general-purpose register file without expanding the registers, examples herein logically combine multiple registers (e.g., four for a 256-bit capability) so that the capability can be split across those multiple underlying registers, e.g., such that general purpose registers of a narrower size can be utilized with the wider format of a capability as compared to a (e.g., narrower sized) pointer.

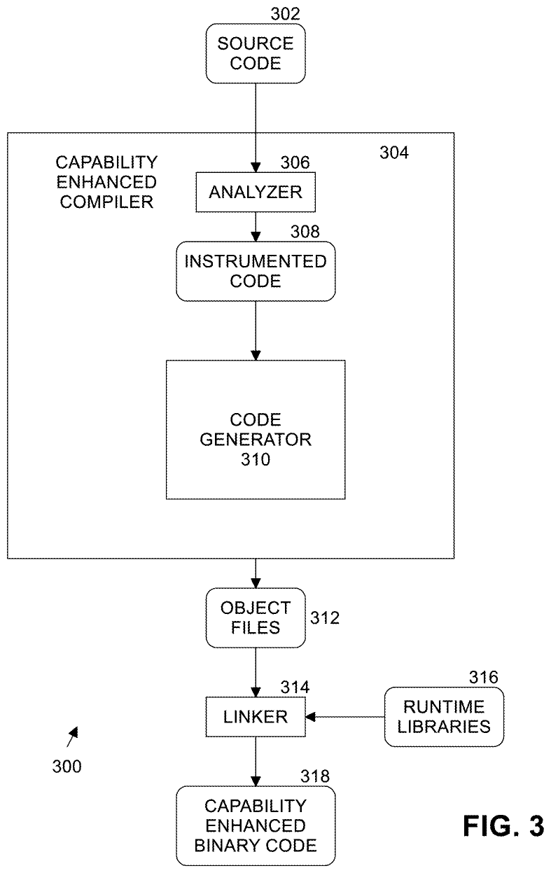

FIG. 3 illustrates a capability enhanced compiler according to one implementation. A program developer writes a computer program represented as source code 302. A compiler adapted as described herein to perform compilation in a manner using capabilities, called capability enhanced compiler 304, analyzes source code 302 with analyzer 306 to generate instrumented code 308. Analyzer 306 performs static analysis of source code 302 to determine if access to allocated memory objects is potentially unsafe. Static analysis to determine which memory safety checks can be elided is a common compiler optimization. For example, static analysis may be used to cause the compiler to only emit dynamic bounds checks where needed.

Instrumented code 308 is input to code generator 310, which produces one or more object files 312 as the output of capability enhanced compiler 104. Code generator 310 generates code for allocating and accessing capabilities or for allocating and accessing unchecked pointers, depending on the results of analyzer 306 analyzing source code 302, for each memory object allocated and subsequently accessed. Linker 314 links the one or more object files 312 with one or more runtime libraries 316 to produce capability enhanced binary code 318. Capability enhanced binary code 318 may then be executed by computing hardware (e.g., hardware processor 100). As described herein, capability enhanced binary code 318 includes efficient code for accessing capabilities (e.g., by accessing 128-bit registers) and for accessing unchecked pointers (e.g., by accessing 64-bit registers).

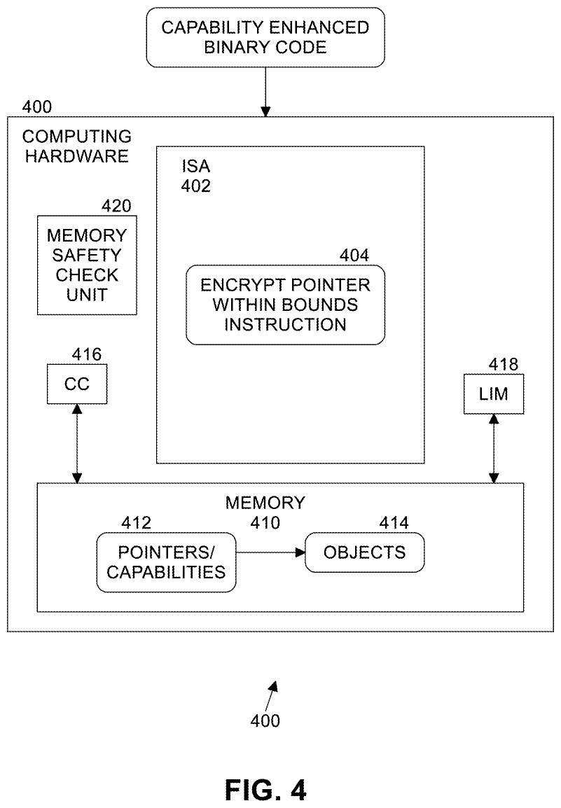

FIG. 4 illustrates example computing hardware 400 according to one implementation. Computing hardware 400 may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to perform cryptographic enforcement of borrow checking as described herein. In one implementation, computing hardware 400 is an example of hardware processor 100 of FIG. 1.

In general, computing hardware 400 may include processing cores, caches, registers, translation lookaside buffers (TLBs), memory management units (MMUs), other processor hardware, input/output (I/O) devices, main memory, secondary memory, other system-level hardware, and other hardware found in processors and computer systems (e.g., as shown in the other processors and computer systems disclosed below). In particular, computing hardware 400 includes an instruction set architecture (ISA) 402. As extended herein, ISA 402 includes encrypt pointer within bounds instruction 404. Compiler 304 generates the encrypt pointer within bounds instruction 404 by code generator 310 as needed. CC 416 includes circuitry as described, for example, in “Cryptographic Computing Using Encrypted Base Addresses and Used in Multi-Tenant Environments”, United States Patent Publication Number US20200201789A1, published on Jun. 25, 2020, and incorporated herein by reference. LEVI 418 includes circuitry as described, for example, in “Data Relocation for Inline Metadata”, US Patent Publication US20210405896 A1, published Dec. 30, 2021, and incorporated herein by reference. Computing hardware 400 also includes circuitry as described in “Pointer Based Data Encryption”, US Patent Publication No. 20200125501A1, published Apr. 23, 2020, and incorporated herein by reference. In one implementation, memory safety check unit 420 comprises circuitry to perform bounds checking of encrypted capabilities.

Memory 410 includes a plurality of objects 414 allocated as a result of executing capability enhanced binary code 318. Objects 414 are referenced by a plurality of pointers and/or capabilities 412.

To be able to enforce bounds checking in computing hardware 400, the design must move beyond representing a pointer as a reference into an undifferentiated, flat memory space. The architecture of computing hardware 400 uniquely identifies each object as well as the object's current owner, which is the sole variable through which the object can be referenced at that time in the program if the object is mutable. If the object is immutable, the object still has an owner, but one or more additional references may exist that can be used to read from the object.

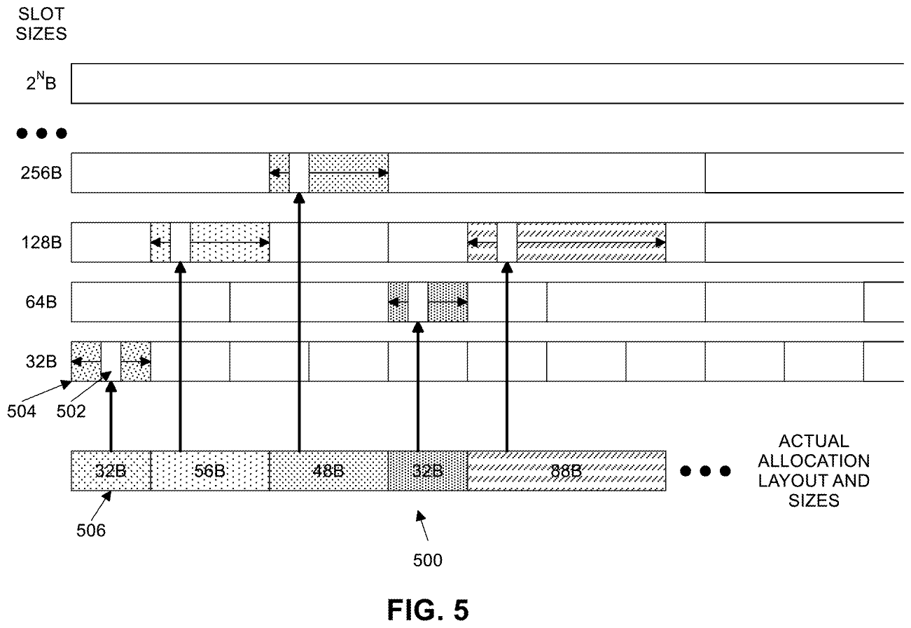

FIG. 5 illustrates assigning memory allocations 500 to best-fitting, power-of-two aligned slots according to one implementation. CC 416 assigns each object to a power-of-two-aligned slot that fits the object best, as illustrated in FIG. 5, and binds the encryption of that object to the object's unique slot. One implementation of CC is described in United States Patent Publication Number US20200201789A1. Further details may be found in “Security Check Systems and Methods for Memory Allocations” US Patent Publication Number US20200379902A1, published Dec. 3, 2020, which is incorporated herein by reference. The slot for an object is encoded into a 64-bit pointer using a compact representation, and the pointer is partially encrypted to mitigate pointer forgery. Data encryption is bound to the encrypted pointer. Any misuse of a pointer to reference a different object will result in incorrect encryption or decryption of that other object. This directly mitigates spatial safety vulnerabilities, and it can also mitigate UAF. If a slot is reused while a dangling pointer still references that exact slot, then UAF may still occur, but a memory allocator can seek to maximize the interval between reuse of a particular slot. Temporarily quarantining a slot does not imply quarantining the underlying memory, which may still be used by assigning the object to a different slot. In one implementation, additional mitigation options for both spatial safety and UAF can be layered on these cryptographic protections to meet language requirements and enhance hardening. For example, the compiler may emit code that performs byte-granular bounds checks and invokes registered code within the program in the event of a bounds check violation. CC encodes pointers to identify their assigned slots.

FIG. 5 shows the assignment of each memory allocation to its best-fitting, power-of-two-aligned slot, and storing metadata inline with allocations. For example, metadata 502 of memory slot 504 for storage of object 506 may store information for assisting in performing bounds checking in one implementation. Note that allocations are not necessarily assigned to the next larger slot size than the allocation size, since they may cross power-of-two alignment boundaries for some of the next possible slot sizes. Each allocation needs to be assigned a slot size that entirely fits the allocation at its particular location in memory without the allocation crossing any slot boundaries at that assigned size. Smaller slots than illustrated here could also be supported similarly. In FIG. 5, the arrows within a memory slot indicate bounds specified in the metadata.

Linear Inline Metadata (LIM) 418 (as disclosed in US Patent Publication US20210405896), may be used to store metadata inline within each object. Specifically, since every object crosses the midpoint of the slot that fits it best, that midpoint is a convenient location to store metadata about the object. The compact pointer encoding only specifies the slot containing the object, not the precise bounds of the object. Thus, even though it is infeasible to store metadata at more obvious locations, such as at the beginning or end of an allocation, a processor of computing hardware 400 can locate metadata in constant time at the midpoint of the slot. Bounds can also be stored in that manner to support byte-granular bounds checks with synchronous exception reporting as required by languages such as Rust. Tags can be stored as well to mitigate spatial safety vulnerabilities that may be missed by bounds checks. Tag checks support generating synchronous exceptions for use after free (UAF) exploits, and the tag is also incorporated into the pointer encryption, which in turn binds the data encryption to the tag.

In one implementation, an encrypt pointer within bounds instruction 404 is added to the instruction set architecture (ISA) 202 of computing hardware 400. The encrypt pointer within bounds instruction is generated by CC compiler 104 as needed. The encrypt pointer within bounds instruction 404, when executed by computing hardware 400, generates a destination encrypted capability that is within the bounds of an explicitly or implicitly supplied source pointer/capability. This instruction helps to enforce a compartmentalized software model such that each compartment is only permitted to generate encrypted capabilities to memory within its own authorized memory region. The bounds describe an object allocated in a memory (e.g., the addresses in memory where the object is stored).

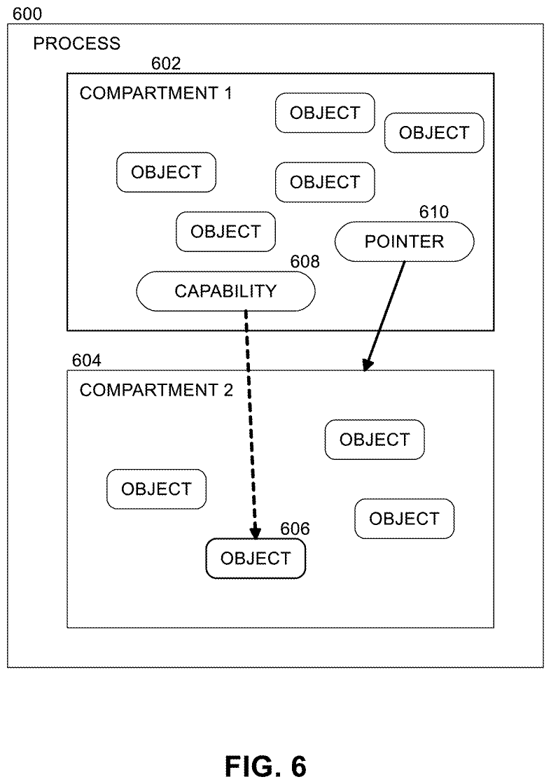

FIG. 6 illustrates an example of two compartments and access to an object by a pointer according to one implementation. Each compartment needs to be able to generate capabilities to each of its own objects and not to any other compartment's objects. The purpose for generating these more specific capabilities rather than just relying on the capabilities for the overall compartment memory regions is two-fold. Each instruction within a compartment should be restricted to only access the object that is supplied to the instruction as an operand. This is to enforce memory safety, e.g., addressing violations such as buffer overflows and use-after-free errors. Compartments need to be permitted to selectively share object references with other compartments while still preventing the receiving compartment from accessing other memory besides just those objects that the sending compartment authorizes it to access.

As shown in the example of FIG. 6, a process 600 of a program (such as source code 302 represented as capability enhanced binary code 318 after compilation) being executed by computing hardware 400 includes two compartments. Compartment 1 602 includes a plurality of objects and compartment 2 604 includes a plurality of objects. In existing systems, pointer 610 has access to all objects in compartment 2 604. By executing the encrypt pointer within bounds instruction 404, the generated capability 608 has access restricted to only object 606, for example, in compartment 2 604 and cannot access the other objects in compartment 2 604.

The encrypt pointer within bounds instruction takes a capability as an input source operand and generates a narrowed and encrypted capability for a specific object as an output destination operand. The encrypted capability may then be used to access only that object within the compartment, or the encrypted capability may be shared across compartment boundaries to selectively grant inter-compartment access to the object.

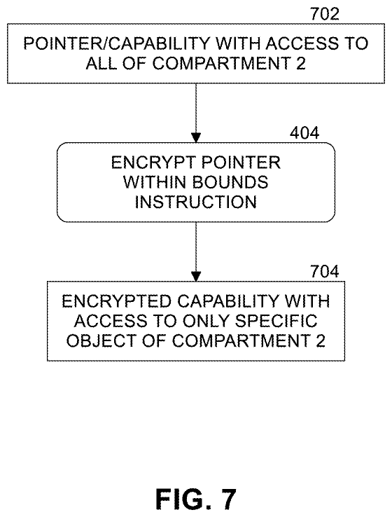

FIG. 7 illustrates an effect of executing an encrypt pointer within bounds instruction 404 according to one implementation. A pointer or capability with access to all of compartment 604 is input to encrypt pointer within bounds instruction 404. Once executed, the instruction generates an encrypted capability with access to only the specific object (e.g., object 606) of compartment 2 604.

A variety of input and/or output pointer/capability formats may be used. For example, a CHERI capability that embeds fine-grained lower and upper bounds within a 128-bit fat pointer format may be used as the input source operand (as shown above in FIGS. 2A and 2B, including bounds 110B), and the encrypt pointer within bounds instruction 404 checks that the desired object bounds are entirely contained by the bounds in the input pointer/capability or generates an exception otherwise.

Another example input capability format is an encrypted pointer that specifies a power-of-two slot (e.g., as shown in US Patent Publication No. 20200125501 A1, “Pointer Based Data Encryption” published Apr. 23, 2020, and hereby incorporated by reference, and US Patent Publication No. 202002011789 A1, “Cryptographic Computing Using Encrypted Base Addresses and Used in Multi-Tenant Environments” published Jun. 25, 2020, and hereby incorporated by reference. The encrypt pointer within bounds instruction 404 checks that the desired object bounds are entirely contained within the power-of-two slot denoted by the input capability.

In one implementation, an implicit operand may be used to supply bounds to check the capability generation request rather than an explicitly specified input operand. For example, as shown in “Encoded Inline Capabilities,” U.S. Pat. No. 10,860,709, issued Dec. 8, 2020, and hereby incorporated by reference, an implicit input operand may specify the power-of-two bounds of the current compartment in specialized registers. Similarly, an extension as described in the RISC-V J extension specification (available from github.com) may also include an implicit input operand with a power-of-two bounds. CHERI introduces a Default Data Capability (DDC) register that has a similar purpose without the constraint that bounds be power-of-two-aligned.

The encrypt pointer within bounds instruction 404 checks that the specified object bounds are entirely contained within the bounds denoted by any of these implicit sources. In other implementations, there may be multiple variants of the encrypt pointer within bounds instruction that can be used within the same program depending on whether implicit or explicit input capabilities are needed for a particular instance of the encrypt pointer within bounds instruction.

In various implementations, the output capability may be encrypted in a format such as that specified in US Patent Publication No. 20200125501 A1, US Patent Publication No. 202002011789 A1, or U.S. Pat. No. 10,860,709. In another implementation, a pair of 64-bit registers may specify the encrypted bounds. In other implementations, any other suitable encrypted pointer or capability format may be used.

In one implementation, the encrypt pointer within bounds instruction 404 may be defined as:

EncryptPtrWithinBounds enc_cap:r64, obj_base:r64, obj_sz:r64, [src_cap:r64/r128]

Execution of this instruction by computing hardware 400 (e.g., a processor or processing core) checks that the object bounds requested using the object base address (obj_base) and object size (ob_sz) operands are entirely contained within the bounds of the implicit or explicit source capability (src_cap), which may be combined with the object base address operand in certain embodiments. If not, an exception is generated. If so, an encrypted capability is generated in the destination operand (encrypted capability (enc_cap)) with the requested object bounds.

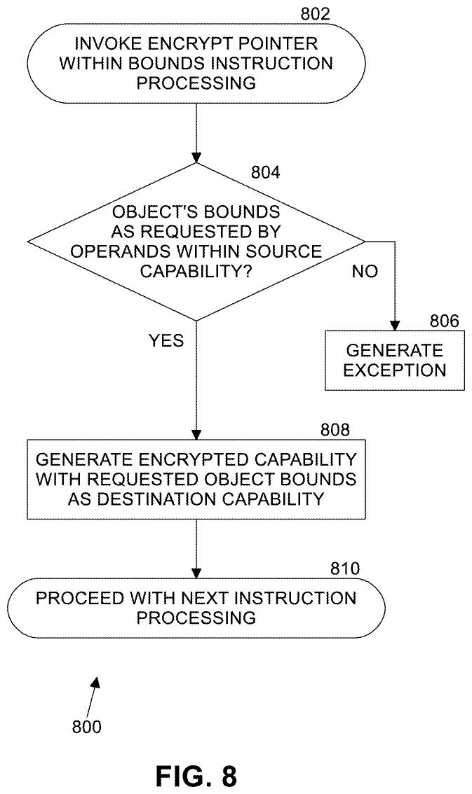

FIG. 8 is a flow diagram of encrypt pointer within bounds instruction processing 800 according to one implementation. At block 802, when a current instruction to be executed by computing hardware 400 is an encrypt pointer within bounds instruction 404, encrypt pointer within bounds instruction processing is invoked at block 802. At block 804, if the object's bounds as requested by the input operands for the object base address (obj_base) and object size (obj_sz) are not entirely contained within the bounds of the implicit or explicit source capability (src_cap), then an exception is generated at block 806. If the object's bounds are within the bounds of the implicit or explicit source capability, then at block 808, computing hardware 400 generates an encrypted capability with the requested object bounds in the destination operand (enc_cap). Computing hardware 400 proceeds with processing of a next instruction at block 810.

Other encrypted security contexts may be inserted into the generated capability after being checked against non-cryptographic metadata in an input capability or other input security metadata. For example, the input may specify one or more allowable tag(s) or version value(s), permission bits, a compartment identifier (ID), privilege level, identifier for code authorized to access the data such as a hash value, key, KeyID, tweak value or initial value (IV)/counter value used by the processor circuitry to encrypt/decrypt data (and/or other metadata) within the respective memory allocation.

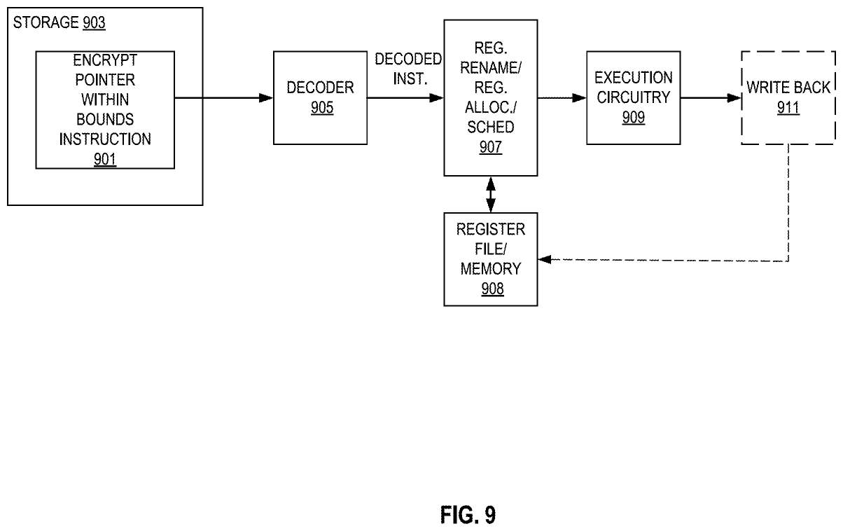

FIG. 9 illustrates examples of computing hardware to process an instruction such as an encrypt pointer within bounds instruction. As illustrated, storage 903 stores an encrypt pointer within bounds instruction 901 to be executed.

The instruction 901 is received by decoder circuitry 905. For example, the decoder circuitry 905 receives this instruction from fetch logic/circuitry. The instruction includes fields for an opcode, source operands (e.g., source capability (src_cap), object base address (obj_base), and object size (ob_sz), and a destination operand (e.g., encrypted capability (enc_cap)). In some examples, the sources and the destination are registers and/or capabilities, and in other examples one or more are memory locations. In some examples, the opcode details generation of an encrypted capability within bounds to be performed.

More detailed examples of at least one instruction format will be detailed later. The decoder circuitry 905 decodes the instruction into one or more operations. In some examples, this decoding includes generating a plurality of micro-operations to be performed by execution circuitry (such as execution circuitry 909). The decoder circuitry 905 also decodes instruction prefixes.

In some examples, register renaming, register allocation, and/or scheduling circuitry 907 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 908 store data as operands of the instruction to be operated on by execution circuitry 909. Exemplary register types include packed data registers, general purpose registers, and floating-point registers.

Execution circuitry 909 executes the decoded instruction. The execution of the decoded instruction causes the execution circuitry to generate an encrypted capability within bounds.

In some examples, retirement/write back circuitry 911 architecturally commits the destination register into the registers or memory 908 and retires the instruction.

An example of a format for an arithmetic recurrence instruction is OPCODE DST, SRC1, SRC2. In some examples, OPCODE is the opcode mnemonic of the instruction. DST is a field for the packed data destination operand. SRC1 and SRC2 are fields for the sources such as packed data registers and/or memory.

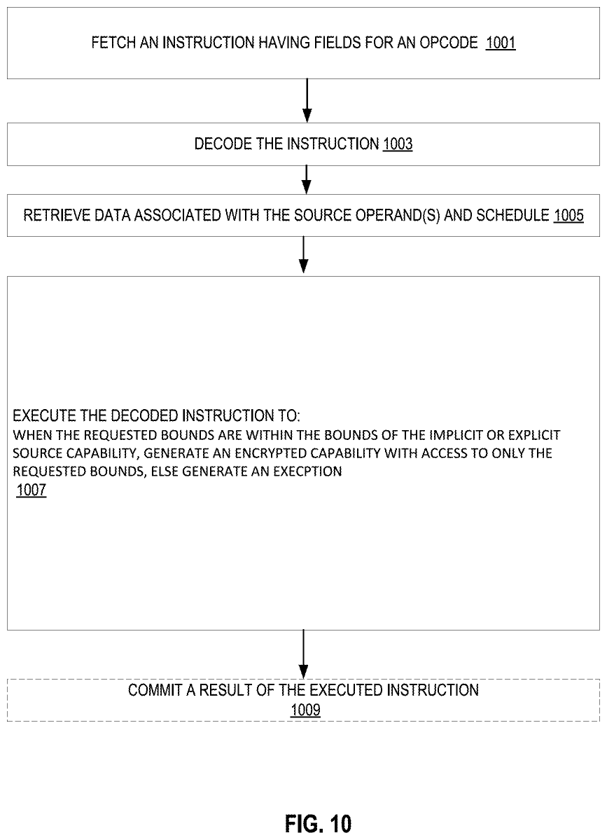

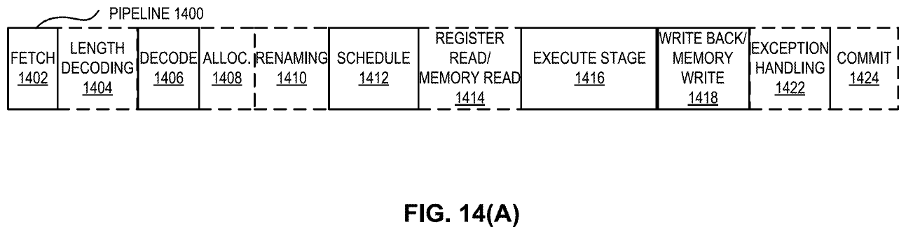

FIG. 10 illustrates an example of method performed by a processor to process an encrypt pointer within bounds instruction. For example, a processor core as shown in FIG. 14(B), a pipeline as detailed below, etc., performs this method.

At 1001, an instance of single instruction is fetched. For example, an encrypt pointer within bounds is fetched. The instruction includes fields for an opcode, a destination encrypted capability, and source operands for source capability, object base address and object size. In some examples, the instruction further includes a field for a writemask. In some examples, the instruction is fetched from an instruction cache.

The fetched instruction is decoded at 1003. For example, the fetched encrypt pointer within bounds instruction is decoded by decoder circuitry such as that detailed herein.

Data values associated with the source operands of the decoded instruction are retrieved when the decoded instruction is scheduled at 1005. For example, when one or more of the source operands are memory operands, the data from the indicated memory location is retrieved.

At 1007, the decoded instruction is executed by execution circuitry (hardware) such as that detailed herein. For the encrypt pointer within bounds instruction, the execution will cause execution circuitry to perform when the requested bounds are within the bounds of the implicit or explicit source capability, generate an encrypted capability with access to only the requested bounds of an object, else generate an exception.

In some examples, the instruction is committed or retired at 1009.

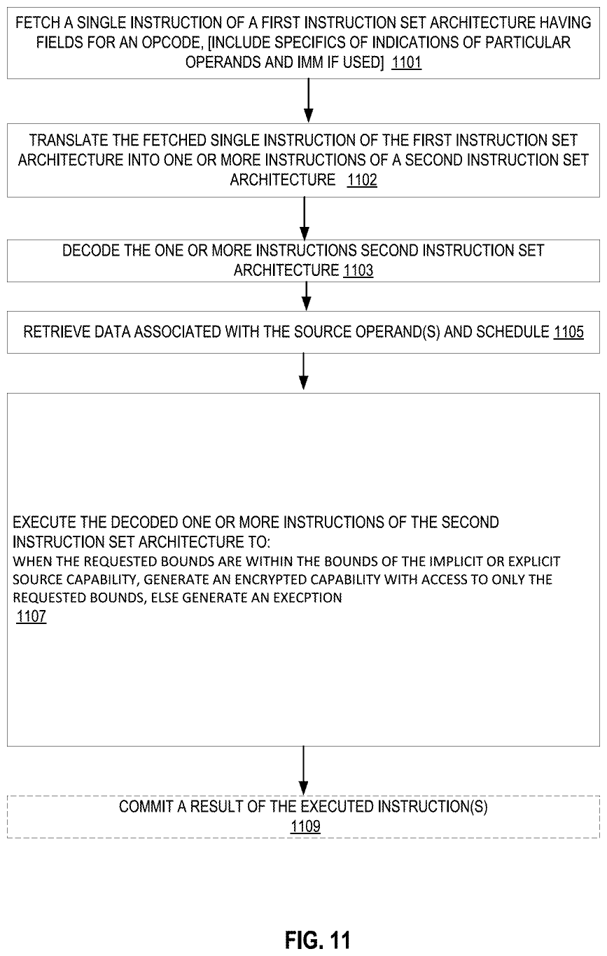

FIG. 11 illustrates an example of method to process an encrypt pointer within bounds instruction using emulation or binary translation. For example, a processor core as shown in FIG. 14(B), a pipeline and/or emulation/translation layer as detailed below, etc., perform aspects of this method.

Translate an instance of a single instruction of a first instruction set architecture into one or more instructions of a second instruction set architecture at 1101. The instance of the single instruction of the first instruction set architecture including fields for an opcode, a destination encrypted capability, and source operands for source capability, object base address and object size. In some examples, the instruction further includes a field for a writemask. In some examples, the instruction is fetched from an instruction cache.

This translation is performed by a translation and/or emulation layer of software in some examples. In some examples, the translation is performed by translation circuitry.

The one or more translated instructions of the second instruction set architecture are decoded at 1103. In some examples, the translation and decoding are merged.

Data values associated with the source operand(s) of the decoded one or more instructions of the second instruction set architecture are retrieved and the one or more instructions are scheduled at 1105. For example, when one or more of the source operands are memory operands, the data from the indicated memory location is retrieved.

At 1107, the decoded instruction(s) of the second instruction set architecture is/are executed by execution circuitry (hardware) such as that detailed herein to perform the operation(s) indicated by the opcode of the single instruction of the first instruction set architecture. For the encrypt pointer within bounds instruction, the execution will cause execution circuitry to perform when the requested bounds are within the bounds of the implicit or explicit source capability, generate an encrypted capability with access to only the requested bounds of an object, else generate an exception.

In some examples, the instruction is committed or retired at 1109.

Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

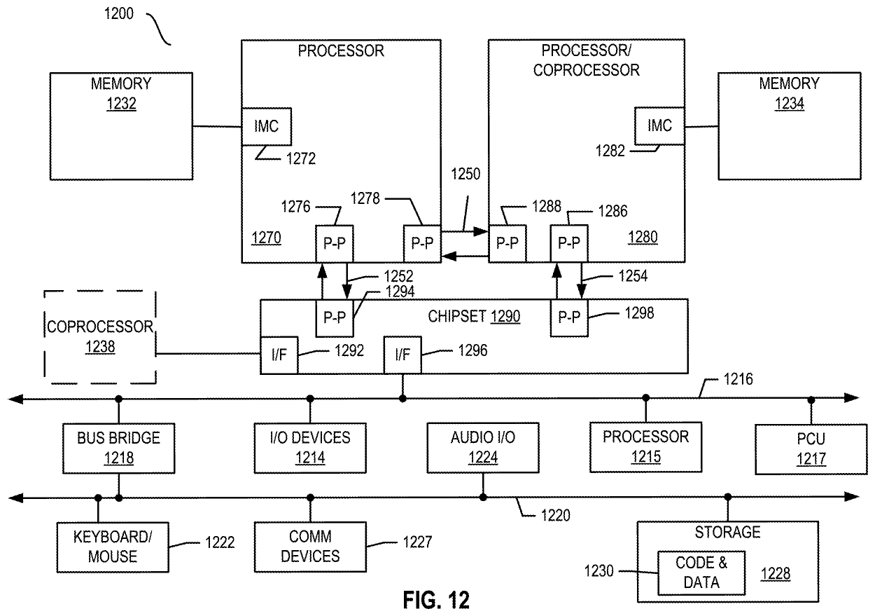

FIG. 12 illustrates an exemplary system. Multiprocessor system 1200 is a point-to-point interconnect system and includes a plurality of processors including a first processor 1270 and a second processor 1280 coupled via a point-to-point interconnect 1250. In some examples, the first processor 1270 and the second processor 1280 are homogeneous. In some examples, first processor 1270 and the second processor 1280 are heterogenous.

Processors 1270 and 1280 are shown including integrated memory controller (IMC) units circuitry 1272 and 1282, respectively. Processor 1270 also includes as part of its interconnect controller units point-to-point (P-P) interfaces 1276 and 1278; similarly, second processor 1280 includes P-P interfaces 1286 and 1288. Processors 1270, 1280 may exchange information via the point-to-point (P-P) interconnect 1250 using P-P interface circuits 1278, 1288. IMCs 1272 and 1282 couple the processors 1270, 1280 to respective memories, namely a memory 1232 and a memory 1234, which may be portions of main memory locally attached to the respective processors.

Processors 1270, 1280 may each exchange information with a chipset 1290 via individual P-P interconnects 1252, 1254 using point to point interface circuits 1276, 1294, 1286, 1298. Chipset 1290 may optionally exchange information with a coprocessor 1238 via a high-performance interface 1292. In some examples, the coprocessor 1238 is a special-purpose processor, such as, for example, a high-throughput processor, a network or communication processor, compression engine, graphics processor, general purpose graphics processing unit (GPGPU), embedded processor, or the like.

A shared cache (not shown) may be included in either processor 1270, 1280 or outside of both processors, yet connected with the processors via P-P interconnect, such that either or both processors' local cache information may be stored in the shared cache if a processor is placed into a low power mode.

Chipset 1290 may be coupled to a first interconnect 1216 via an interface 1296. In some examples, first interconnect 1216 may be a Peripheral Component Interconnect (PCI) interconnect, or an interconnect such as a PCI Express interconnect or another I/O interconnect. In some examples, one of the interconnects couples to a power control unit (PCU) 1217, which may include circuitry, software, and/or firmware to perform power management operations with regard to the processors 1270, 1280 and/or co-processor 1238. PCU 1217 provides control information to a voltage regulator (not shown) to cause the voltage regulator to generate the appropriate regulated voltage. PCU 1217 also provides control information to control the operating voltage generated. In various examples, PCU 1217 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1217 is illustrated as being present as logic separate from the processor 1270 and/or processor 1280. In other cases, PCU 1217 may execute on a given one or more of cores (not shown) of processor 1270 or 1280. In some cases, PCU 1217 may be implemented as a microcontroller (dedicated or general-purpose) or other control logic configured to execute its own dedicated power management code, sometimes referred to as P-code. In yet other examples, power management operations to be performed by PCU 1217 may be implemented externally to a processor, such as by way of a separate power management integrated circuit (PMIC) or another component external to the processor. In yet other examples, power management operations to be performed by PCU 1217 may be implemented within BIOS or other system software.

Various I/O devices 1214 may be coupled to first interconnect 1216, along with a bus bridge 1218 which couples first interconnect 1216 to a second interconnect 1220. In some examples, one or more additional processor(s) 1215, such as coprocessors, high-throughput many integrated core (MIC)processors, GPGPUs, accelerators (such as graphics accelerators or digital signal processing (DSP) units), field programmable gate arrays (FPGAs), or any other processor, are coupled to first interconnect 1216. In some examples, second interconnect 1220 may be a low pin count (LPC) interconnect. Various devices may be coupled to second interconnect 1220 including, for example, a keyboard and/or mouse 1222, communication devices 1227 and a storage circuitry 1228. Storage circuitry 1228 may be a disk drive or other mass storage device which may include instructions/code and data 1230, in some examples. Further, an audio I/O 1224 may be coupled to second interconnect 1220. Note that other architectures than the point-to-point architecture described above are possible. For example, instead of the point-to-point architecture, a system such as multiprocessor system 1200 may implement a multi-drop interconnect or other such architecture.

Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

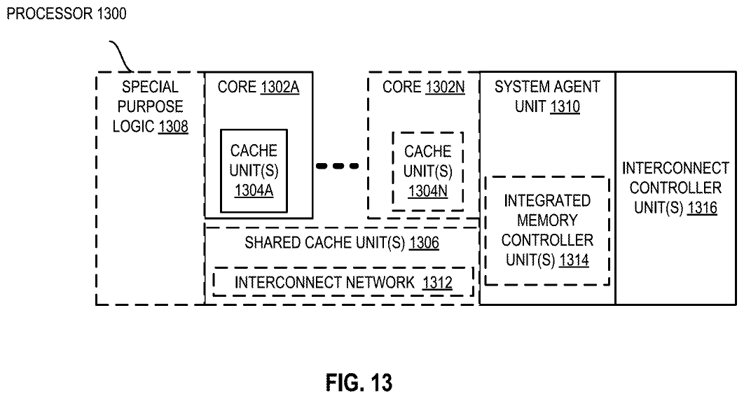

FIG. 13 illustrates a block diagram of an example processor 1300 that may have more than one core and an integrated memory controller. The solid lined boxes illustrate a processor 1300 with a single core 1302A, a system agent 1310, a set of one or more interconnect controller unit(s) circuitry 1316, while the optional addition of the dashed lined boxes illustrates an alternative processor 1300 with multiple cores 1302(A)-(N), a set of one or more integrated memory controller unit(s) circuitry 1314 in the system agent unit circuitry 1310, and special purpose logic 1308, as well as a set of one or more interconnect controller units circuitry 1316. Note that the processor 1300 may be one of the processors 1270 or 1280, or co-processor 1238 or 1215 of FIG. 12.

Thus, different implementations of the processor 1300 may include: 1) a CPU with the special purpose logic 1308 being integrated graphics and/or scientific (throughput) logic (which may include one or more cores, not shown), and the cores 1302(A)-(N) being one or more general purpose cores (e.g., general purpose in-order cores, general purpose out-of-order cores, or a combination of the two); 2) a coprocessor with the cores 1302(A)-(N) being a large number of special purpose cores intended primarily for graphics and/or scientific (throughput); and 3) a coprocessor with the cores 1302(A)-(N) being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, bipolar complementary metal oxide semiconductor (CMOS) (BiCMOS), CMOS, or N-type metal oxide semiconductor (NMOS).

A memory hierarchy includes one or more levels of cache unit(s) circuitry 1304(A)-(N) within the cores 1302(A)-(N), a set of one or more shared cache unit(s) circuitry 1306, and external memory (not shown) coupled to the set of integrated memory controller unit(s) circuitry 1314. The set of one or more shared cache unit(s) circuitry 1306 may include one or more mid-level caches, such as level 2 (L2), level 3 (L3), level 4 (L4), or other levels of cache, such as a last level cache (LLC), and/or combinations thereof. While in some examples ring-based interconnect network circuitry 1312 interconnects the special purpose logic 1308 (e.g., integrated graphics logic), the set of shared cache unit(s) circuitry 1306, and the system agent unit circuitry 1310, alternative examples use any number of well-known techniques for interconnecting such units. In some examples, coherency is maintained between one or more of the shared cache unit(s) circuitry 1306 and cores 1302(A)-(N).

In some examples, one or more of the cores 1302(A)-(N) are capable of multi-threading. The system agent unit circuitry 1310 includes those components coordinating and operating cores 1302(A)-(N). The system agent unit circuitry 1310 may include, for example, power control unit (PCU) circuitry and/or display unit circuitry (not shown). The PCU may be or may include logic and components needed for regulating the power state of the cores 1302(A)-(N) and/or the special purpose logic 1308 (e.g., integrated graphics logic). The display unit circuitry is for driving one or more externally connected displays.

The cores 1302(A)-(N) may be homogenous or heterogeneous in terms of architecture instruction set architecture (ISA); that is, two or more of the cores 1302(A)-(N) may be capable of executing the same ISA, while other cores may be capable of executing only a subset of that ISA or a ISA.

Exemplary Core Architectures In-Order and Out-of-Order Core Block Diagram.

FIG. 14(A) is a block diagram illustrating both an exemplary in-order pipeline and an exemplary register renaming, out-of-order issue/execution pipeline according to examples. FIG. 14(B) is a block diagram illustrating both an exemplary example of an in-order architecture core and an exemplary register renaming, out-of-order issue/execution architecture core to be included in a processor according to examples. The solid lined boxes in FIGS. 14(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14(A), a processor pipeline 1400 includes a fetch stage 1402, an optional length decoding stage 1404, a decode stage 1406, an optional allocation (Alloc) stage 1408, an optional renaming stage 1410, a schedule (also known as a dispatch or issue) stage 1412, an optional register read/memory read stage 1414, an execute stage 1416, a write back/memory write stage 1418, an optional exception handling stage 1422, and an optional commit stage 1424. One or more operations can be performed in each of these processor pipeline stages. For example, during the fetch stage 1402, one or more instructions are fetched from instruction memory, during the decode stage 1406, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1406 and the register read/memory read stage 1414 may be combined into one pipeline stage. In one example, during the execute stage 1416, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution core architecture may implement the pipeline 1400 as follows: 1) the instruction fetch 1438 performs the fetch and length decoding stages 1402 and 1404; 2) the decode circuitry 1440 performs the decode stage 1406; 3) the rename/allocator unit circuitry 1452 performs the allocation stage 1408 and renaming stage 1410; 4) the scheduler(s) circuitry 1456 performs the schedule stage 1412; 5) the physical register file(s) circuitry 1458 and the memory unit circuitry 1470 perform the register read/memory read stage 1414; the execution cluster(s) 1460 perform the execute stage 1416; 6) the memory unit circuitry 1470 and the physical register file(s) circuitry 1458 perform the write back/memory write stage 1418; 7) various circuitry may be involved in the exception handling stage 1422; and 8) the retirement unit circuitry 1454 and the physical register file(s) circuitry 1458 perform the commit stage 1424.

FIG. 14(B) shows processor core 1490 including front-end unit circuitry 1430 coupled to an execution engine unit circuitry 1450, and both are coupled to a memory unit circuitry 1470. The core 1490 may be a reduced instruction set architecture computing (RISC) core, a complex instruction set architecture computing (CISC) core, a very long instruction word (VLIW) core, or a hybrid or alternative core type. As yet another option, the core 1490 may be a special-purpose core, such as, for example, a network or communication core, compression engine, coprocessor core, general purpose computing graphics processing unit (GPGPU) core, graphics core, or the like.

The front end unit circuitry 1430 may include branch prediction circuitry 1432 coupled to an instruction cache circuitry 1434, which is coupled to an instruction translation lookaside buffer (TLB) 1436, which is coupled to instruction fetch circuitry 1438, which is coupled to decode circuitry 1440. In one example, the instruction cache circuitry 1434 is included in the memory unit circuitry 1470 rather than the front-end circuitry 1430. The decode circuitry 1440 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1440 may further include an address generation unit circuitry (AGU, not shown). In one example, the AGU generates an LSU address using forwarded register ports, and may further perform branch forwarding (e.g., immediate offset branch forwarding, LR register branch forwarding, etc.). The decode circuitry 1440 may be implemented using various different mechanisms. Examples of suitable mechanisms include, but are not limited to, look-up tables, hardware implementations, programmable logic arrays (PLAs), microcode read only memories (ROMs), etc. In one example, the core 1490 includes a microcode ROM (not shown) or other medium that stores microcode for certain macroinstructions (e.g., in decode circuitry 1440 or otherwise within the front end circuitry 1430). In one example, the decode circuitry 1440 includes a micro-operation (micro-op) or operation cache (not shown) to hold/cache decoded operations, micro-tags, or micro-operations generated during the decode or other stages of the processor pipeline 1400. The decode circuitry 1440 may be coupled to rename/allocator unit circuitry 1452 in the execution engine circuitry 1450.

The execution engine circuitry 1450 includes the rename/allocator unit circuitry 1452 coupled to a retirement unit circuitry 1454 and a set of one or more scheduler(s) circuitry 1456. The scheduler(s) circuitry 1456 represents any number of different schedulers, including reservations stations, central instruction window, etc. In some examples, the scheduler(s) circuitry 1456 can include arithmetic logic unit (ALU) scheduler/scheduling circuitry, ALU queues, arithmetic generation unit (AGU) scheduler/scheduling circuitry, AGU queues, etc. The scheduler(s) circuitry 1456 is coupled to the physical register file(s) circuitry 1458. Each of the physical register file(s) circuitry 1458 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1458 includes vector registers unit circuitry, writemask registers unit circuitry, and scalar register unit circuitry. These register units may provide architectural vector registers, vector mask registers, general-purpose registers, etc. The physical register file(s) circuitry 1458 is overlapped by the retirement unit circuitry 1454 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1454 and the physical register file(s) circuitry 1458 are coupled to the execution cluster(s) 1460. The execution cluster(s) 1460 includes a set of one or more execution unit(s) circuitry 1462 and a set of one or more memory access circuitry 1464. The execution unit(s) circuitry 1462 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1456, physical register file(s) circuitry 1458, and execution cluster(s) 1460 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1464). It should also be understood that where separate pipelines are used, one or more of these pipelines may be out-of-order issue/execution and the rest in-order.

In some examples, the execution engine unit circuitry 1450 may perform load store unit (LSU) address/data pipelining to an Advanced Microcontroller Bus (AMB) interface (not shown), and address phase and writeback, data phase load, store, and branches.

The set of memory access circuitry 1464 is coupled to the memory unit circuitry 1470, which includes data TLB circuitry 1472 coupled to a data cache circuitry 1474 coupled to a level 2 (L2) cache circuitry 1476. In one exemplary example, the memory access circuitry 1464 may include a load unit circuitry, a store address unit circuit, and a store data unit circuitry, each of which is coupled to the data TLB circuitry 1472 in the memory unit circuitry 1470. The instruction cache circuitry 1434 is further coupled to a level 2 (L2) cache circuitry 1476 in the memory unit circuitry 1470. In one example, the instruction cache 1434 and the data cache 1474 are combined into a single instruction and data cache (not shown) in L2 cache circuitry 1476, a level 3 (L3) cache circuitry (not shown), and/or main memory. The L2 cache circuitry 1476 is coupled to one or more other levels of cache and eventually to a main memory.

The core 1490 may support one or more instructions sets (e.g., the x86 instruction set architecture (with some extensions that have been added with newer versions); the MIPS instruction set architecture; the ARM instruction set architecture (with optional additional extensions such as NEON)), including the instruction(s) described herein. In one example, the core 1490 includes logic to support a packed data instruction set architecture extension (e.g., AVX1, AVX2), thereby allowing the operations used by many multimedia applications to be performed using packed data.

Exemplary Execution Unit(s) Circuitry.

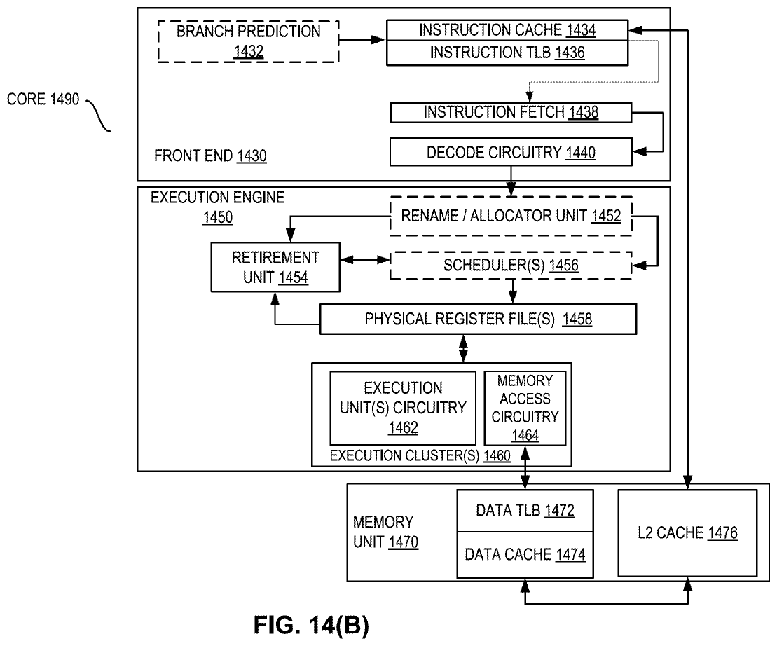

FIG. 15 illustrates examples of execution unit(s) circuitry, such as execution unit(s) circuitry 1462 of FIG. 14(B). As illustrated, execution unit(s) circuitry 1462 may include one or more ALU circuits 1501, vector/single instruction multiple data (SIMD) circuits 1503, load/store circuits 1505, and/or branch/jump circuits 1507. ALU circuits 1501 perform integer arithmetic and/or Boolean operations. Vector/SIMD circuits 1503 perform vector/SIMD operations on packed data (such as SIMD/vector registers). Load/store circuits 1505 execute load and store instructions to load data from memory into registers or store from registers to memory. Load/store circuits 1505 may also generate addresses. Branch/jump circuits 1507 cause a branch or jump to a memory address depending on the instruction. Floating-point unit (FPU) circuits 1509 perform floating-point arithmetic. The width of the execution unit(s) circuitry 1462 varies depending upon the example and can range from 16-bit to 1,024-bit. In some examples, two or more smaller execution units are logically combined to form a larger execution unit (e.g., two 128-bit execution units are logically combined to form a 256-bit execution unit).

Exemplary Register Architecture.

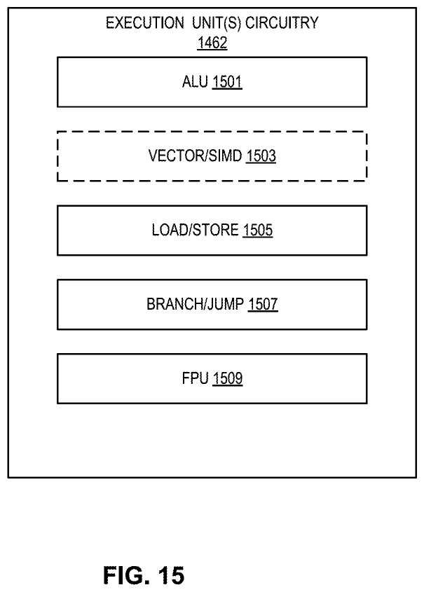

FIG. 16 is a block diagram of a register architecture 1600 according to some examples. As illustrated, there are vector/SIMD registers 1610 that vary from 128-bit to 1,024 bits width. In some examples, the vector/SIMD registers 1610 are physically 512-bits and, depending upon the mapping, only some of the lower bits are used. For example, in some examples, the vector/SIMD registers 1610 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1600 includes writemask/predicate registers 1615. For example, in some examples, there are 8 writemask/predicate registers (sometimes called k0 through k7) that are each 16-bit, 32-bit, 64-bit, or 128-bit in size. Writemask/predicate registers 1615 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1615 corresponds to a data element position of the destination. In other examples, the writemask/predicate registers 1615 are scalable and consists of a set number of enable bits for a given vector element (e.g., 8 enable bits per 64-bit vector element).

The register architecture 1600 includes a plurality of general-purpose registers 1625. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1600 includes scalar floating-point (FP) register 1645 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1640 (e.g., EFLAGS, RFLAGS, etc.) store status and control information for arithmetic, compare, and system operations. For example, the one or more flag registers 1640 may store condition code information such as carry, parity, auxiliary carry, zero, sign, and overflow. In some examples, the one or more flag registers 1640 are called program status and control registers.

Segment registers 1620 contain segment points for use in accessing memory. In some examples, these registers are referenced by the names CS, DS, SS, ES, FS, and GS.

Machine specific registers (MSRs) 1635 control and report on processor performance. Most MSRs 1635 handle system-related functions and are not accessible to an application program. Machine check registers 1660 consist of control, status, and error reporting MSRs that are used to detect and report on hardware errors.

One or more instruction pointer register(s) 1630 store an instruction pointer value. Control register(s) 1655 (e.g., CR0-CR4) determine the operating mode of a processor (e.g., processor 1270, 1280, 1238, 1215, and/or 1300) and the characteristics of a currently executing task. Debug registers 1650 control and allow for the monitoring of a processor or core's debugging operations.

Memory (mem) management registers 1665 specify the locations of data structures used in protected mode memory management. These registers may include a GDTR, IDRT, task register, and a LDTR register.

Alternative examples may use wider or narrower registers. Additionally, alternative examples may use more, less, or different register files and registers.

Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

Exemplary Instruction Formats.

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

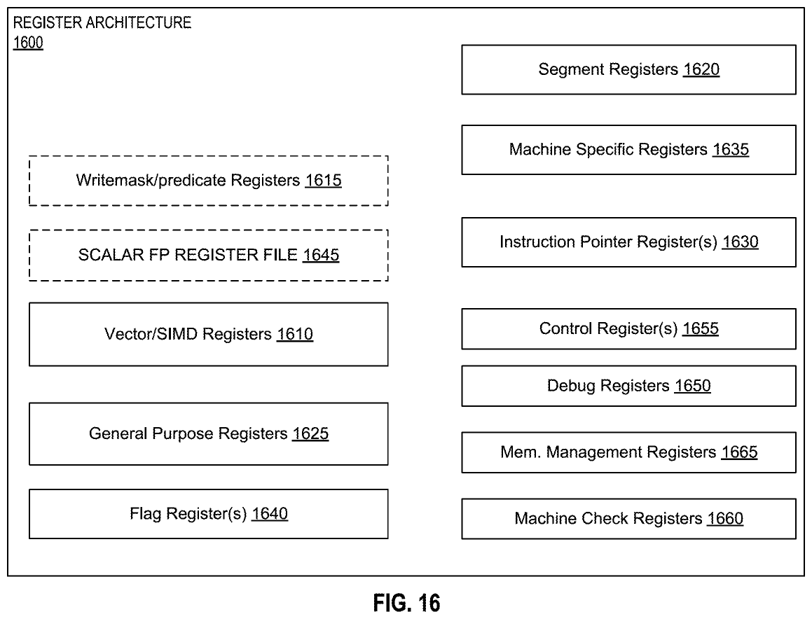

FIG. 17 illustrates examples of an instruction format. As illustrated, an instruction may include multiple components including, but not limited to, one or more fields for: one or more prefixes 1701, an opcode 1703, addressing information 1705 (e.g., register identifiers, memory addressing information, etc.), a displacement value 1707, and/or an immediate value 1709. Note that some instructions utilize some or all of the fields of the format whereas others may only use the field for the opcode 1703. In some examples, the order illustrated is the order in which these fields are to be encoded, however, it should be appreciated that in other examples these fields may be encoded in a different order, combined, etc.

The prefix(es) field(s) 1701, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1703 is used to at least partially define the operation to be performed upon a decoding of the instruction. In some examples, a primary opcode encoded in the opcode field 1703 is one, two, or three bytes in length. In other examples, a primary opcode can be a different length. An additional 3-bit opcode field is sometimes encoded in another field.

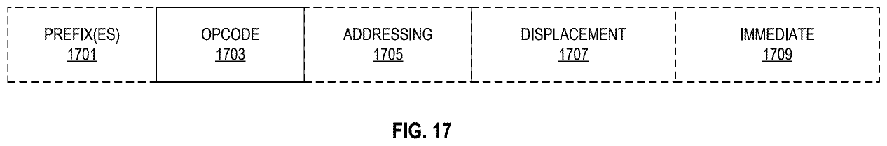

The addressing field 1705 is used to address one or more operands of the instruction, such as a location in memory or one or more registers. FIG. 18 illustrates examples of the addressing field 1705. In this illustration, an optional ModR/M byte 1802 and an optional Scale, Index, Base (SIB) byte 1804 are shown. The ModR/M byte 1802 and the SIB byte 1804 are used to encode up to two operands of an instruction, each of which is a direct register or effective memory address. Note that each of these fields are optional in that not all instructions include one or more of these fields. The MOD R/M byte 1802 includes a MOD field 1842, a register (reg) field 1844, and R/M field 1846.

The content of the MOD field 1842 distinguishes between memory access and non-memory access modes. In some examples, when the MOD field 1842 has a value of b11, a register-direct addressing mode is utilized, and otherwise register-indirect addressing is used.

The register field 1844 may encode either the destination register operand or a source register operand, or may encode an opcode extension and not be used to encode any instruction operand. The content of register index field 1844, directly or through address generation, specifies the locations of a source or destination operand (either in a register or in memory). In some examples, the register field 1844 is supplemented with an additional bit from a prefix (e.g., prefix 1701) to allow for greater addressing.

The R/M field 1846 may be used to encode an instruction operand that references a memory address or may be used to encode either the destination register operand or a source register operand. Note the R/M field 1846 may be combined with the MOD field 1842 to dictate an addressing mode in some examples.

The SIB byte 1804 includes a scale field 1852, an index field 1854, and a base field 1856 to be used in the generation of an address. The scale field 1852 indicates scaling factor. The index field 1854 specifies an index register to use. In some examples, the index field 1854 is supplemented with an additional bit from a prefix (e.g., prefix 1701) to allow for greater addressing. The base field 1856 specifies a base register to use. In some examples, the base field 1856 is supplemented with an additional bit from a prefix (e.g., prefix 1701) to allow for greater addressing. In practice, the content of the scale field 1852 allows for the scaling of the content of the index field 1854 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, a displacement 1707 provides this value. Additionally, in some examples, a displacement factor usage is encoded in the MOD field of the addressing field 1705 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 1707.

In some examples, an immediate field 1709 specifies an immediate value for the instruction. An immediate value may be encoded as a 1-byte value, a 2-byte value, a 4-byte value, etc.

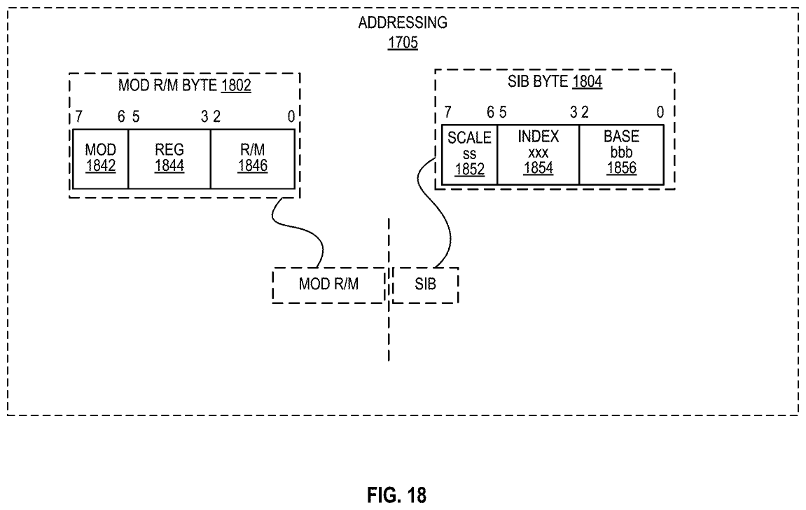

FIG. 19 illustrates examples of a first prefix 1701(A). In some examples, the first prefix 1701(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1701(A) may specify up to three registers using 3-bit fields depending on the format: 1) using the reg field 1844 and the R/M field 1846 of the Mod R/M byte 1802; 2) using the Mod R/M byte 1802 with the SIB byte 1804 including using the reg field 1844 and the base field 1856 and index field 1854; or 3) using the register field of an opcode.

In the first prefix 1701(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1844 and MOD R/M R/M field 1846 alone can each only address 8 registers.

In the first prefix 1701(A), bit position 2 (R) may an extension of the MOD R/M reg field 1844 and may be used to modify the ModR/M reg field 1844 when that field encodes a general purpose register, a 64-bit packed data register (e.g., a SSE register), or a control or debug register. R is ignored when Mod R/M byte 1802 specifies other registers or defines an extended opcode.

Bit position 1 (X) X bit may modify the SIB byte index field 1854.

Bit position B (B) B may modify the base in the Mod R/M R/M field 1846 or the SIB byte base field 1856; or it may modify the opcode register field used for accessing general purpose registers (e.g., general purpose registers 1625).

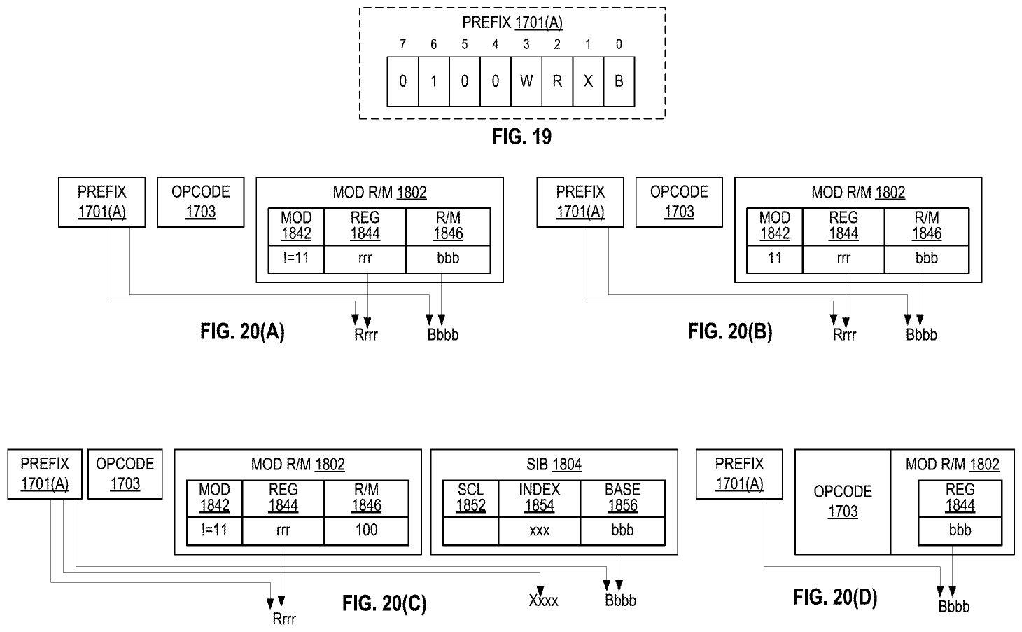

FIGS. 20(A)-(D) illustrate examples of how the R, X, and B fields of the first prefix 1701(A) are used. FIG. 20(A) illustrates R and B from the first prefix 1701(A) being used to extend the reg field 1844 and R/M field 1846 of the MOD R/M byte 1802 when the SIB byte 18 04 is not used for memory addressing. FIG. 20(B) illustrates R and B from the first prefix 1701(A) being used to extend the reg field 1844 and R/M field 1846 of the MOD R/M byte 1802 when the SIB byte 18 04 is not used (register-register addressing). FIG. 20(C) illustrates R, X, and B from the first prefix 1701(A) being used to extend the reg field 1844 of the MOD R/M byte 1802 and the index field 1854 and base field 1856 when the SIB byte 18 04 being used for memory addressing. FIG. 20(D) illustrates B from the first prefix 1701(A) being used to extend the reg field 1844 of the MOD R/M byte 1802 when a register is encoded in the opcode 1703.

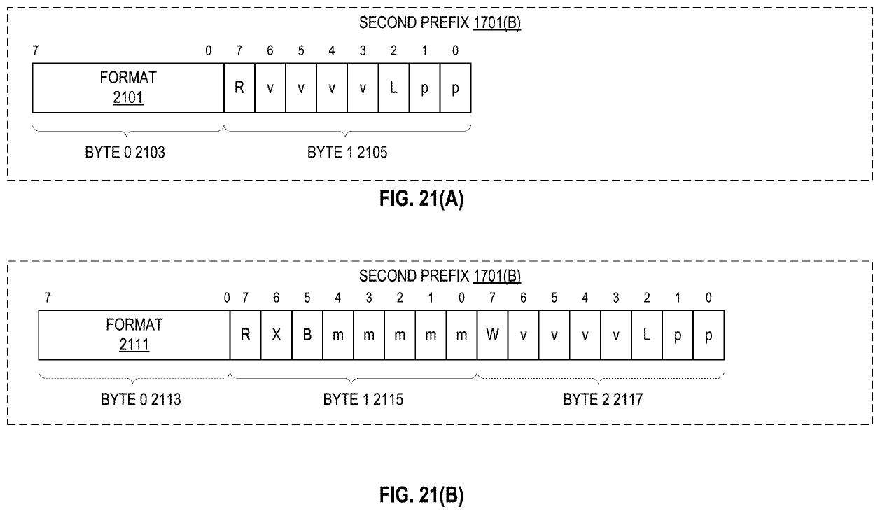

FIGS. 21(A)-(B) illustrate examples of a second prefix 1701(B). In some examples, the second prefix 1701(B) is an example of a VEX prefix. The second prefix 1701(B) encoding allows instructions to have more than two operands, and allows SIMD vector registers (e.g., vector/SIMD registers 1610) to be longer than 64-bits (e.g., 128-bit and 256-bit). The use of the second prefix 1701(B) provides for three-operand (or more) syntax. For example, previous two-operand instructions performed operations such as A=A+B, which overwrites a source operand. The use of the second prefix 1701(B) enables operands to perform nondestructive operations such as A=B+C.

In some examples, the second prefix 1701(B) comes in two forms—a two-byte form and a three-byte form. The two-byte second prefix 1701(B) is used mainly for 128-bit, scalar, and some 256-bit instructions; while the three-byte second prefix 1701(B) provides a compact replacement of the first prefix 1701(A) and 3-byte opcode instructions.

FIG. 21(A) illustrates examples of a two-byte form of the second prefix 1701(B). In one example, a format field 2101 (byte 0 2103) contains the value CSH. In one example, byte 1 2105 includes a “R” value in bit[7]. This value is the complement of the same value of the first prefix 1701(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1846 to encode the instruction operand that references a memory address or encode either the destination register operand or a source register operand.

Instructions that use this prefix may use the Mod R/M reg field 1844 to encode either the destination register operand or a source register operand, be treated as an opcode extension and not used to encode any instruction operand.

For instruction syntax that support four operands, vvvv, the Mod R/M R/M field 1846 and the Mod R/M reg field 1844 encode three of the four operands. Bits[7:4] of the immediate 1709 are then used to encode the third source register operand.

FIG. 21(B) illustrates examples of a three-byte form of the second prefix 1701(B). in one example, a format field 2111 (byte 0 2113) contains the value C4H. Byte 1 2115 includes in bits[7:5] “R,” “X,” and “B” which are the complements of the same values of the first prefix 1701(A). Bits[4:0] of byte 1 2115 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 2117 is used similar to W of the first prefix 1701(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1846 to encode the instruction operand that references a memory address or encode either the destination register operand or a source register operand.

Instructions that use this prefix may use the Mod R/M reg field 1844 to encode either the destination register operand or a source register operand, be treated as an opcode extension and not used to encode any instruction operand.

For instruction syntax that support four operands, vvvv, the Mod R/M R/M field 1846, and the Mod R/M reg field 1844 encode three of the four operands. Bits[7:4] of the immediate 1709 are then used to encode the third source register operand.

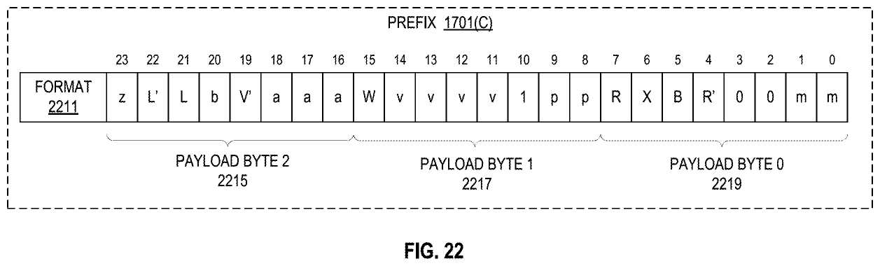

FIG. 22 illustrates examples of a third prefix 1701(C). In some examples, the first prefix 1701(A) is an example of an EVEX prefix. The third prefix 1701(C) is a four-byte prefix.

The third prefix 1701(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 16) or predication utilize this prefix. Opmask register allow for conditional processing or selection control. Opmask instructions, whose source/destination operands are opmask registers and treat the content of an opmask register as a single value, are encoded using the second prefix 1701(B).

The third prefix 1701(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1701(C) is a format field 2211 that has a value, in one example, of 62H. Subsequent bytes are referred to as payload bytes 2215-2219 and collectively form a 24-bit value of P[23:0] providing specific capability in the form of one or more fields (detailed herein).

In some examples, P[1:0] of payload byte 2219 are identical to the low two mmmmm bits. P[3:2] are reserved in some examples. Bit P[4] (R′) allows access to the high 16 vector register set when combined with P[7] and the ModR/M reg field 1844. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1844 and ModR/M R/M field 1846. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1701(A) and second prefix 1711(B) and may serve as an opcode extension bit or operand size promotion.

P[18:16] specify the index of a register in the opmask (writemask) registers (e.g., writemask/predicate registers 1615). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary examples of encoding of registers in instructions using the third prefix 1701(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

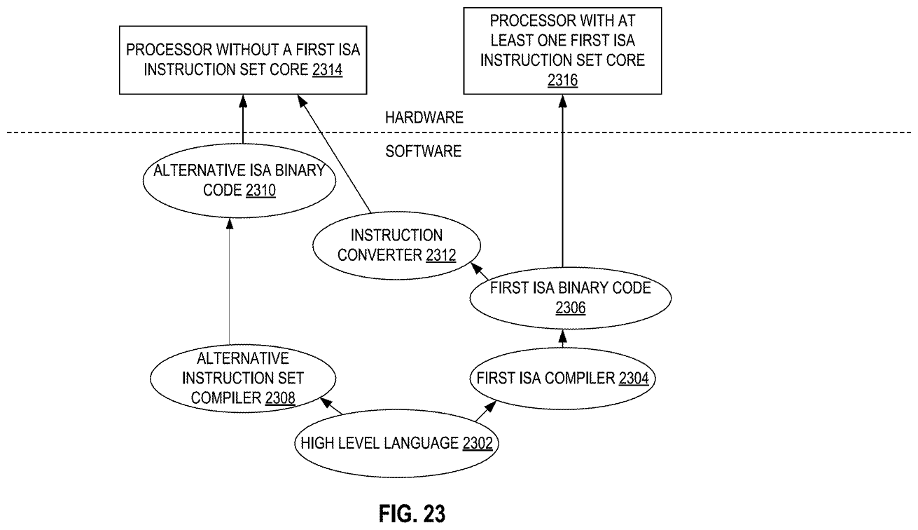

FIG. 23 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 23 shows a program in a high-level language 2302 may be compiled using a first ISA compiler 2304 to generate first ISA binary code 2306 that may be natively executed by a processor with at least one first instruction set architecture core 2316. The processor with at least one first ISA instruction set architecture core 2316 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 2304 represents a compiler that is operable to generate first ISA binary code 2306 (e.g., object code) that can, with or without additional linkage processing, be executed on the processor with at least one first ISA instruction set architecture core 2316. Similarly, FIG. 23 shows the program in the high-level language 2302 may be compiled using an alternative instruction set architecture compiler 2308 to generate alternative instruction set architecture binary code 2310 that may be natively executed by a processor without a first ISA instruction set architecture core 2314. The instruction converter 2312 is used to convert the first ISA binary code 2306 into code that may be natively executed by the processor without a first ISA instruction set architecture core 2314. This converted code is not likely to be the same as the alternative instruction set architecture binary code 2310 because an instruction converter capable of this is difficult to make; however, the converted code will accomplish the general operation and be made up of instructions from the alternative instruction set architecture. Thus, the instruction converter 2312 represents software, firmware, hardware, or a combination thereof that, through emulation, simulation or any other process, allows a processor or other electronic device that does not have a first ISA instruction set architecture processor or core to execute the first ISA binary code 2306.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). As such, disjunctive language is not intended to, nor should it be understood to, imply that a given example requires at least one of A, at least one of B, or at least one of C to each be present.

### Example Embodiments

The following examples pertain to further embodiments. Specifics in the examples may be used anywhere in one or more embodiments. Example 1 is an apparatus including decoder circuitry to decode a single instruction, the single instruction to include a field for an identifier of a first source operand, a field for an identifier of a second source operand, a field for an identifier of a destination operand, and a field for an opcode, the opcode to indicate execution circuitry is to generate an encrypted capability within bounds; and execution circuitry to execute the decoded instruction according to the opcode to generate an encrypted capability, with access to bounds specified by the first source operand and the second source operand, in the destination operand based at least in part on a source capability when the bounds are within bounds of the source capability.

In Example 2, the subject matter of Example 1 can optionally include wherein the execution circuitry is to execute the decoded instruction according to the opcode to generate an exception when the bounds specified by the first source operand and the second source operand are not within the bounds of the source capability. In Example 3, the subject matter of Example 1 can optionally include wherein the first source operand comprises a base address of an object in a memory. In Example 4, the subject matter of Example 3 can optionally include wherein the second source operand comprises a size of the object in a memory. In Example 5, the subject matter of Example 1 can optionally include wherein the source capability comprises an explicit operand specified as a third source operand of the single instruction. In Example 6, the subject matter of Example 1 can optionally include wherein the source capability comprises an implicit operand. In Example 7, the subject matter of Example 1 can optionally include wherein the first source operand comprises a base address of an object in a memory, the second source operand comprises a size of the object in the memory and the object is allocated in the memory to a best-fitting, power-of-two-aligned slot. In Example 8, the subject matter of Example 1 can optionally include wherein the bounds of the source capability describe an object allocated in a memory. In Example 9, the subject matter of Example 1 can optionally include wherein the source capability has access to a compartment and the encrypted capability has access only to an object allocated to a memory in the compartment, storage of the object in the memory being described by the first source operand and the second source operand.

Example 10 is a method including generating an encrypted capability with access only to specified bounds of a source capability when the specified bounds are within bounds of the source capability, and; generating an exception when the specified bounds are not within bounds of the source capability. In Example 11, the subject matter of Example 10 can optionally include wherein the specified bounds comprise a base address and a size of an object allocated in a memory. In Example 12, the subject matter of Example 10 can optionally include wherein the source capability comprises an explicit operand of an encrypt pointer within bounds instruction. In Example 13, the subject matter of Example 10 can optionally include wherein the source capability comprises an implicit operand of an encrypt pointer within bounds instruction. In Example 14, the subject matter of Example 10 can optionally include wherein the specified bounds comprise a base address and a size of an object allocated in a memory and the object is allocated in the memory to a best-fitting, power-of-two-aligned slot. In Example 15, the subject matter of Example 10 can optionally include wherein the bounds of the source capability describe an object allocated in a memory. In Example 16, the subject matter of Example 10 can optionally include wherein the source capability has access to a compartment and the encrypted capability has access only to an object allocated to a memory in the compartment, storage of the object in the memory being described by the specified bounds.

Example 17 is a system including a memory to store an object referenced by a source capability; and a processor, the processor including decoder circuitry to decode a single instruction, the single instruction to include a field for an identifier of a first source operand, a field for an identifier of a second source operand, a field for an identifier of a destination operand, and a field for an opcode, the opcode to indicate execution circuitry is to generate an encrypted capability within bounds; and execution circuitry to execute the decoded instruction according to the opcode to generate an encrypted capability, with access to bounds specified by the first source operand and the second source operand, in the destination operand based at least in part on a source capability when the bounds are within bounds of the source capability.

In Example 18, the subject matter of Example 17 can optionally include wherein the processor is to execute the decoded instruction according to the opcode to generate an exception when the bounds specified by the first source operand and the second source operand are not within the bounds of the source capability. In Example 19, the subject matter of Example 17 can optionally include wherein the first source operand comprises a base address of the object. In Example 20, the subject matter of Example 19 can optionally include wherein the second source operand comprises a size of the object in a memory. In Example 21, the subject matter of Example 17 can optionally include wherein the source capability comprises an explicit operand specified as a third source operand of the single instruction. In Example 22, the subject matter of Example 17 can optionally include wherein the source capability comprises an implicit operand. In Example 23, the subject matter of Example 17 can optionally include wherein the first source operand comprises a base address of the object, the second source operand comprises a size of the object and the object is allocated in the memory to a best-fitting, power-of-two-aligned slot. In Example 24, the subject matter of Example 17 can optionally include wherein the bounds of the source capability describe the object. In Example 25, the subject matter of Example 17 can optionally include wherein the source capability has access to a compartment and the encrypted capability has access only to the object in the compartment, storage of the object being described by the first source operand and the second source operand.

Example 26 is an apparatus operative to perform the method of any one of Examples 10 to 16. Example 27 is an apparatus that includes means for performing the method of any one of Examples 10 to 16. Example 28 is an apparatus that includes any combination of modules and/or units and/or logic and/or circuitry and/or means operative to perform the method of any one of Examples 10 to 16. Example 29 is an optionally non-transitory and/or tangible machine-readable medium, which optionally stores or otherwise provides instructions that if and/or when executed by a computer system or other machine are operative to cause the machine to perform the method of any one of Examples 10 to 16.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode a single instruction, the single instruction to include a field for an identifier of a first source operand, a field for an identifier of a second source operand, a field for an identifier of a destination operand, and a field for an opcode, the opcode to indicate execution circuitry is to generate an encrypted capability within bounds; and
execution circuitry to execute the decoded instruction according to the opcode to generate an encrypted capability, with access to bounds specified by the first source operand and the second source operand, in the destination operand based at least in part on a source capability when the bounds are within bounds of the source capability.

2. The apparatus of claim 1, wherein the execution circuitry is to execute the decoded instruction according to the opcode to generate an exception when the bounds specified by the first source operand and the second source operand are not within the bounds of the source capability.

3. The apparatus of claim 1, wherein the first source operand comprises a base address of an object in a memory.

4. The apparatus of claim 3, wherein the second source operand comprises a size of the object in a memory.

5. The apparatus of claim 1, wherein the source capability comprises an explicit operand specified as a third source operand of the single instruction.

6. The apparatus of claim 1, wherein the source capability comprises an implicit operand.

7. The apparatus of claim 1, wherein the first source operand comprises a base address of an object in a memory, the second source operand comprises a size of the object in the memory and the object is allocated in the memory to a best-fitting, power-of-two-aligned slot.

8. The apparatus of claim 1, wherein the bounds of the source capability describe an object allocated in a memory.

9. The apparatus of claim 1, wherein the source capability has access to a compartment and the encrypted capability has access only to an object allocated to a memory in the compartment, storage of the object in the memory being described by the first source operand and the second source operand.

10. A method comprising:
generating an encrypted capability with access only to specified bounds of a source capability when the specified bounds are within bounds of the source capability, and;
generating an exception when the specified bounds are not within bounds of the source capability.

11. The method of claim 10, wherein the specified bounds comprise a base address and a size of an object allocated in a memory.

12. The method of claim 10, wherein the source capability comprises an explicit operand of an encrypt pointer within bounds instruction.

13. The method of claim 10, wherein the source capability comprises an implicit operand of an encrypt pointer within bounds instruction.

14. The method of claim 10, wherein the specified bounds comprise a base address and a size of an object allocated in a memory and the object is allocated in the memory to a best-fitting, power-of-two-aligned slot.

15. The method of claim 10, wherein the bounds of the source capability describe an object allocated in a memory.

16. The method of claim 10, wherein the source capability has access to a compartment and the encrypted capability has access only to an object allocated to a memory in the compartment, storage of the object in the memory being described by the specified bounds.

17. A system comprising:
a memory to store an object referenced by a source capability; and
a processor, the processor comprising
decoder circuitry to decode a single instruction, the single instruction to include a field for an identifier of a first source operand, a field for an identifier of a second source operand, a field for an identifier of a destination operand, and a field for an opcode, the opcode to indicate execution circuitry is to generate an encrypted capability within bounds; and
execution circuitry to execute the decoded instruction according to the opcode to generate an encrypted capability, with access to bounds specified by the first source operand and the second source operand, in the destination operand based at least in part on a source capability when the bounds are within bounds of the source capability.

18. The system of claim 17, wherein the processor is to execute the decoded instruction according to the opcode to generate an exception when the bounds specified by the first source operand and the second source operand are not within the bounds of the source capability.

19. The system of claim 17, wherein the first source operand comprises a base address of the object.

20. The system of claim 19, wherein the second source operand comprises a size of the object in a memory.

21. The system of claim 17, wherein the source capability comprises an explicit operand specified as a third source operand of the single instruction.

22. The system of claim 17, wherein the source capability comprises an implicit operand.

23. The system of claim 17, wherein the first source operand comprises a base address of the object, the second source operand comprises a size of the object and the object is allocated in the memory to a best-fitting, power-of-two-aligned slot.

24. The system of claim 17, wherein the bounds of the source capability describe the object.

25. The system of claim 17, wherein the source capability has access to a compartment and the encrypted capability has access only to the object in the compartment, storage of the object being described by the first source operand and the second source operand.
